(19) United States
(12) Patent Application Publication
(10) Pub. No.: US 2026/0156588 A1
(43) Pub. Date: Jun. 4, 2026

(54) Low Impedance Radio Frequency Antennas

(71) Applicant: Northeastern University, Boston, MA (US)

(72) Inventors: Luca COLOMBO, Boston, MA (US); Giuseppe MICHETTI, Somerville, MA (US); Matteo RINALDI, Boston, MA (US)

(21) Appl. No.: 18/706,582

(22) PCT Filed: Dec. 14, 2022
(86) PCT No.: PCT/US2022/052850

§ 371 Date: May 1, 2024

Related U.S. Application Data
(60) Provisional application No. 63/289,272, filed on Dec. 14, 2021.

(51) Int. Cl. H04W 52/52; H04W 52/02

(52) U.S. Cl. CPC H04W 52/52; H04W 52/0235

(57) ABSTRACT

Wake-up receivers (WuRx) are provided including an antenna having a real input impedance different than 50Ω configured for receiving a radiofrequency (RF) signal, resonant circuitry configured to provide voltage gain to the received RF signal to produce a boosted RF signal, and a passive rectifier configured to at least one of recover a data signal from the boosted RF signal, or convert the boosted RF signal into a DC power signal.

### CROSS REFERENCE TO RELATED APPLICATIONS

This application claims benefit under 35 U.S.C. § 119(e) of U.S. Provisional Application No. 63/289,272, filed on 14 Dec. 2021, entitled “Low Impedance Radio Frequency Antennas,” the entirety of which is incorporated by reference herein.

### BACKGROUND

The fast-paced and world-wide evolution of remote sensor networks, commonly referred to as Internet of Things (IoT), has fostered research and development of novel radio frequency (RF) energy transducers, capable of mitigating IoT nodes challenges including power consumption, sensitivity, communication range, and ultimately maintenance cost.

As the latest trends confirm, billions of IoT devices will be deployed all over the planet with the task of collecting data, mostly in areas where little if any human intervention is foreseen.

For these applications, novel radio paradigms are being investigated to reduce the power consumption of IoT nodes, typically limited by recovery and decoding of RF signals, so as to lower maintenance costs and ease deployment of a large number of devices. In this framework, wake-up receivers (WuRx) can be used to recover wake-up signals, that can ultimately be used to query asynchronous information from an IoT device with nW power consumption. WuRxs operate under completely different conditions and constraints than conventional receiver (Rx) circuitry, therefore novel designs are needed to deploy RF front-ends that are specific to WuRx.

Typical power consumption for cellular IoT devices in IDLE mode, where they spend majority of their time waiting for a paging message, is in order of 10s of mW. These devices have to trade-off increased paging latency for reducing power consumption. On-demand, infrequent wake-up event features are not only critical for enhancing the battery life for IoT devices, but they also play an instrumental role in reducing paging latency. The vision to deploy WuRx on a largescale and marketable platform has consolidated over the last 2 years with the emergence of IEEE802.11ba that defines and regulates the operation of ultra-low power architectures as part of the IEEE standard 802.11 (i.e. Wi-Fi®). Consequently, an increasing number of works are being published to provide early-stage performance evaluation on event-driven networks such as the ones discussed herein.

In the growing Narrow-Band (NB) IoT spectrum, the frequency bands between 800 and 900 MHz (NB-IoT Bands 18,19, and 20) are of great interest, as up and downlink segments are being allocated in the 3GPP release 13 to enhance cellular communication services supporting such low-power architectures. Even if the proposed technique is frequency agnostic, this work showcases devices and radio performance for an RF front-end operating around 820 MHz, demonstrating a systematic approach to obtain better performance in relevant low-power NB-IoT bands.

Micro-acoustic MEMS resonators have led the RF filter market for mobile radios throughout the 4G communication era, due to achievable mechanical quality factors in the order of 1000s in the VHF range, in a compact form factor (typically few hundreds of μm2 area) and with processes compatible with CMOS manufacturing, therefore marketable when mass produced.

When implementing such resonators as matching elements at the WuRx interface, gains of 38 dB and 32 dB have been recently demonstrated using MEMS resonators, respectively at 110 MHz and 570 MHz by Colombo et al.

While an extensive literature exists on ICs tailored for sub μW RF signal detection and on high-Q mechanical resonators deployed to provide large passive voltage amplification, antenna design is always assumed to be a given.

### Emerging RF Communication Architectures

Conventional over-the-air RF communication systems rely on a chain of power-matched networks. A schematic representation of a typical network is shown in FIG. 1 and applies both to RF receivers (Rx) and transmitters (Tx). For Tx, the input signal propagates through a medium (typically a transmission line) and it is delivered to a radiating load (the antenna), which typically requires an ad-hoc matching network to minimize unwanted reflections. Similarly, an Rx signal is transduced by the antenna and, through the matching and propagating sections, gets delivered to the readout circuitry.

A classical requirement for the operation of RF networks is that each section has to carry signal propagation with the same wave impedance Z₀. Satisfying this requirement guarantees broadband response from the transmission lines, low signal loss through the matching elements, and maximized power efficiency to and from the antenna. In turn, this conventional scheme results in power-hungry transistor-based RF circuitry because transistor-based RF blocks are subject to stringent noise-power tradeoffs and are consequently incompatible with the remote deployment of autonomous over-the-air IoT nodes.

To surpass these limits, an asynchronous WuRx paradigm has been proposed and developed (FIG. 2). In WuRx, the incoming RF signal is used to energize a nonlinear passive network that is able to trigger a response signifying a received stream of digital information. This rectification process is typically realized by means of diode-based circuits or electrostatic MEMS demodulators.

A number of system-level aspects can be drawn from the use of such rectifiers. First and foremost, the low-power Rx's signal is delivered to a capacitive network, hence and ideally no direct power transfer is realized. Second, the filtering stage required at the antenna front-end acts as a passive voltage amplifier, boosting the received signal's voltage at the rectifier input and providing interference rejection from unwanted signals at other RF carriers.

The described WuRx architecture so far does not allow for high-throughput and wide-band signal recovery. However, this is hardly required in IoT applications where rare event-driven handshakes have to be exchanged, and on the contrary power savings are of the utmost importance. Recent works have shown how piezoelectric MEMS resonators can be used to design miniaturized high-Q matching networks to be deployed in this context.

### SUMMARY

Provided herein are low impedance antennae for use in connection with wake-up receivers (WuRx) in connection with either or both of information receivers and/or energy harvesters (EH).

In one aspect a wake-up receiver (WuRx) is provided. The WuRx includes an antenna having a real input impedance different than 50Ω configured for receiving a radiofrequency (RF) signal. The WuRx also includes resonant circuitry configured to provide voltage gain to the received RF signal to produce a boosted RF signal. The WuRx also includes a passive rectifier configured to at least one of recover a data signal from the boosted RF signal or convert the boosted RF signal into a DC power signal.

In some embodiments, the passive rectifier is integrated in a semiconductor integrated chip. In some embodiments, the passive rectifier includes a diode rectifier. In some embodiments, the WuRx also includes a load capacitor for storing the boosted RF signal when a voltage of the boosted RF signal exceeds a threshold voltage. In some embodiments, the threshold voltage is higher than a minimum voltage for which messages can be decoded by the WuRx. In some embodiments, the threshold voltage is higher than a voltage of the received RF signal. In some embodiments, the resonant circuitry includes a reactive tank including one or more circuit elements. In some embodiments, the resonant circuitry includes a micro-acoustic MEMS resonator.

In some embodiments, the antenna is an open-end, center-fed, dipole-like antenna. In some embodiments, the antenna is a meander antenna. In some embodiments, the antenna is a single-ended meander antenna. In some embodiments, the antenna includes a single-ended meandered antenna dipole. In some embodiments, the antenna is grounded. In some embodiments, the antenna structure includes a construction having a bottom metal ground pour as a path for return RF currents. In some embodiments, the path for return RF currents results in antenna excitation including a ground connection to break symmetry of differential dipoles of the antenna. In some embodiments, breaking the symmetry of the differential dipoles of the antenna halves electro-magnetic energy storage in the meander. In some embodiments, the antenna is a double dipole antenna. In some embodiments, the antenna is a planar antenna. In some embodiments, the real input impedance of the antenna is less than 50Ω. In some embodiments, inductance and/or capacitance of the antenna produces a tunable complex impedance of the antenna exceeding 50Ω. In some embodiments, the resonant circuitry is sized to resonate a load reactance of the WuRx.

In another aspect, a method for wake-up signal detection is provided. The method includes receiving, with an antenna having a real input impedance different than 50Ω, a radiofrequency (RF) signal. The method also includes providing, by resonant circuitry, voltage gain to the received RF signal to produce a boosted RF signal. The method also includes, by a passive rectifier, at least one of recovering a data signal from the boosted RF signal or converting the boosted RF signal into a DC power signal.

In some embodiments, the steps of receiving, providing, recovering, and converting are performed using the WuRx of any of the aspects described above.

Additional features and aspects of the technology include the following:
1. A wake-up receiver (WuRx) comprising:
   an antenna having a real input impedance different than 50Ω configured for receiving a radiofrequency (RF) signal;
   resonant circuitry configured to provide voltage gain to the received RF signal to produce a boosted RF signal; and
   a passive rectifier configured to at least one of:
      recover a data signal from the boosted RF signal, or
      convert the boosted RF signal into a DC power signal.
2. The WuRx of feature 1, wherein the passive rectifier is integrated in a semiconductor integrated chip.
3 The WuRx of claim any of the preceding features, wherein the passive rectifier includes a diode rectifier.
4. The WuRx of any of the preceding features, further comprising a load capacitor for storing the boosted RF signal when a voltage of the boosted RF signal exceeds a threshold voltage.
5. The WuRx of feature 4, wherein the threshold voltage is higher than a minimum voltage for which messages can be decoded by the WuRx.
6. The WuRx of feature 5, wherein the threshold voltage is higher than a voltage of the received RF signal.
7. The WuRx of any of the preceding features, wherein the resonant circuitry includes a reactive tank including one or more circuit elements.
8. The WuRx of any of the preceding features, wherein the resonant circuitry includes a micro-acoustic MEMS resonator.
9. The WuRx of any of the preceding features, wherein the antenna is an open-end, center-fed, dipole-like antenna.
10. The WuRx of feature 9, wherein the antenna is a meander antenna.
11. The WuRx of any of features 9-10, wherein the antenna is a single-ended meander antenna.
12. The WuRx of feature 11, wherein the antenna includes a single-ended meandered antenna dipole.
13. The WuRx of any of features 11-12, wherein the antenna is grounded.
14. The WuRx of feature 13, wherein the antenna structure includes a construction having a bottom metal ground pour as a path for return RF currents.
15. The WuRx of feature 14, wherein the path for return RF currents results in antenna excitation including a ground connection to break symmetry of differential dipoles of the antenna.
16. The WuRx of feature 15, wherein breaking the symmetry of the differential dipoles of the antenna halves electro-magnetic energy storage in the meander.
17. The WuRx of any of features 1-6, wherein the antenna is a double dipole antenna.
18. The WuRx of any of features 1-6, wherein the antenna is a planar antenna.
19. The WuRx of any of the preceding features, wherein the real input impedance of the antenna is less than 50Ω.
20. The WuRx of feature 19, wherein inductance and/or capacitance of the antenna produces a tunable complex impedance of the antenna exceeding 50Ω.
21. The WuRx of any of the preceding features, wherein the resonant circuitry is sized to resonate a load reactance of the WuRx.
22. A method for wake-up signal detection comprising:
   receiving, with an antenna having a real input impedance different than 50Ω, a radiofrequency (RF) signal;
   providing, by resonant circuitry, voltage gain to the received RF signal to produce a boosted RF signal; and
   by a passive rectifier, at least one of recovering a data signal from the boosted RF signal or converting the boosted RF signal into a DC power signal.

23. The method of feature 22, wherein the steps of receiving, providing, recovering, and converting are performed using the WuRx of any of claims 1-21.

### DESCRIPTION OF THE DRAWINGS

FIG. 1 illustrates a conventional passive Tx-Rx chain for RF signals in accordance with the prior art. Each section is power matched so that wave impedance is maintained constant throughout the chain, and Tx-Rx signals can be recovered/delivered without reflections. The matching section provides frequency selectivity to the desired channel, and/or Tx-side impedance conversion to the Rx impedance level, so to avoid signal to noise ratio degradation introduced in the unavoidable propagation network.

FIG. 2 illustrates a simplified schematic of a WuRx architecture in accordance with the prior art. The RF signal does not travel through the conventional chain of FIG. 1, but it is used to energize a RF-to-DC passive rectifier, typically implemented with semiconductor ICs, so to recover incoming data. In this context, the matching section acts as a transformer for the Rx signal. These passive filters can be used to provide large voltage gain, increasing the overall Rx sensitivity.

FIG. 3A illustrates a WuRx RF front-end circuit-level schematic wherein VRF voltage is picked up by an antenna and excites the nonlinearity of a rectifier when the VEM amplitude exceeds a certain threshold Vth. When the information is coded into an Amplitude Modulated signal, the envelope of the signal is reproduced as voltage on a load capacitor C_{load}, and it is therefore ready to be digitized.

FIG. 3B illustrates an exemplary thin-film piezoelectric RF resonator deployed to resonate Cj,0. The Modified Butterworth-Van-Dyke (MBVD) electrical resonator model highlights the motional inductance Lm used to bring the circuit into resonance.

FIG. 3C illustrates a SPICE level simulated voltage gain Gv, mapped in the color bar, for a typical MEMS resonator FoM and external quality factors Qe (discussed below), MEMS capacitance C0=Cj,0, and electro-mechanical coupling coefficient

$${k}_{t}^{2} = 10 \% .$$

FIG. 4A illustrates an overview of antenna nodes in a center-fed current-mode antenna wherein x is the spatial coordinate of radiating side of an antenna. Below current/voltage distribution, a qualitative response of the input impedance shape realized by the current-mode antenna is shown wherein the resonance condition corresponds to a minimum of Zᵢₙ, as large currents are excited at the feed-point.

FIG. 4B illustrates an overview of antenna nodes in a voltage-mode antenna. x is the spatial coordinate of radiating side of an antenna. Below current/voltage distribution, a qualitative response of the input impedance shape realized by the voltage-mode antenna is shown wherein the resonance condition corresponds to a maximum of Zᵢₙ, as large voltages are excited at the feed-point.

FIG. 5A illustrates a schematic of antenna geometry and an antenna excitation port for a conventional differential dipole.

FIG. 5B illustrates an antenna impedance analysis of the conventional differential dipole of FIG. 5A, showing magnitude of input impedance frequency response for various Lₐᵣₘ, for a reference width of 5 mm and a 2 mm gap. For these designs, Rant does not vary with Lₐᵣₘ and is approximately matched to 50Ω.

FIG. 6A illustrates a schematic of a differential meandered antenna geometry, highlighting its excitation port and the arm length Lant, wherein, for a fixed arm length Lant, as the number of turns Nₜᵤᵣₙₛ increases, overall antenna width increases and antenna length decreases.

FIG. 6B illustrates a plot of obtained Rant and Fres versus Nₜᵤᵣₙₛ, showing that Rant decreases monotonically with Nₜᵤᵣₙₛ.

FIG. 6C illustrates a plot of magnitude of input impedance frequency response for various Larm for a reference width of 5 mm and a 2 mm gap.

FIG. 6D illustrates a plot of magnitude of input impedance frequency response for various Nₜᵤᵣₙₛ for a reference width of 5 mm and a 2 mm gap. Comparing 6C-6D with FIG. 5B, it can be inferred that the meander antenna displays higher Q_{rad} and therefore lower usable bandwidth.

FIG. 7A illustrates antenna geometry and an antenna excitation port for a meandered WuRx monopole antenna.

FIG. 7B illustrates a plot of magnitude of input impedance frequency response for various Larm when ground size is large enough to neglect border effects (e.g., L_{ground} and W_{ground}=200 mm).

FIG. 7C illustrates a plot of Rant and Fres versus Larm.

FIG. 7D illustrates a plot of Rant and Fres versus Nₜᵤᵣₙₛ. FIGS. 7C-7D illustrate similar impedance trends vs Lₐᵣₘ to a conventional dipole, whereas impedance trends vs Nₜᵤᵣₙₛ are similar to the response shown in FIGS. 6B & 6D, showing viability of the meandered WuRx monopole antenna of FIG. 7A as a single-ended version of the differential meandered antenna of FIG. 6A. The WuRx monopole antenna is thus compatible with single-ended low power WuRx designs.

FIG. 8A illustrates a circuit schematic of a WuRx having a MEMS resonator (modeled via its MBVD model) resonating a complementary actuated diode rectifier, followed by a commercial comparator used to discriminate bit stream.

FIG. 8B illustrates an EM simulation setup for RF voltage gain Gv of MEMS matched WuRx integrated on PCB, with the modeling of integration parasitics via wire-bonding as shown in the inset.

FIG. 8C illustrates simulated Gv for various resonator impedances Z0, obtained in Momentum engine, with SPICE-level modeling of a SBX201C Onsemi® Schottky diode used as RF rectifier. For the resonator,

$${k}_{t}^{2} = 7 \% ,$$

Qm=550 was assumed, to reflect the performance of the in-house fabricated FBAR resonator in FIG. 6. Z0 represents the impedance of the static MEMS resonator capacitance C0 at resonance.

FIG. 9A illustrates a simulated radiation pattern for the meandered WuRx monopole antenna of FIG. 7A. The slight elongation in the Y direction is aligned with the direction of meander folding. Backside radiation is not blocked by the ground plane, as the meander is not covered by bottom plane. As a result, the maximum antenna directivity approaches the dipole directivity (2.5 dB).

FIG. 9B illustrates a current distribution of the meandered WuRx monopole antenna of FIG. 7A at resonance, indicating a higher current concentration in close proximity to the electrical port (e.g., the vertical port excitation as shown).

FIG. 10A illustrates the effect of ground size on the meandered WuRx monopole antenna of FIG. 7A, wherein W_{ground}=L_{ground}.

FIG. 10B illustrates a comparison between the conventional differential dipole of FIG. 5A having a Larm of 110 mm, the differential meandered antenna of FIG. 6A having a Larm of 75 mm, and the meandered WuRx monopole antenna of FIG. 7A having a Larm of 80 mm. While the differential dipole antenna has a lower Q_{rad} 16, the differential meander antenna has a Q_{rad} 40. As per the single-ended meander antenna (FIG. 7A) very low Q_{rad} 10 is obtained for large L_{ground}=200 mm, while the desired low Rₐₙₜ 10Ω is retained. It is noted that, due to corner effect, necessary Lₐᵣₘ required to operate around 800 MHz slightly changes for the various implementations.

FIG. 11A illustrates a one-port S-parameters test setup, including a coaxial section, an on-board fixture, and a device under test (DUT).

FIG. 11B illustrates error induced on antenna parameters (Rₐₙₜ, Fᵣₑₛ) simulated in FIGS. 7A-7D, as a function of fixture delay Δψ. Despite a short length (as low as λ/16), significant error is predicted.

FIG. 11C illustrates a conventional fixture calibration measurement setup, where an unknown fixture is cascaded with its reverse.

FIG. 11D illustrates additional fixture characterization measurement, based on a-priori knowledge of a known impedance. Using measured results from 11C-11D, the fixture response can be extrapolated analytically.

FIG. 12A illustrates a prototyped PCB Antenna with annotated critical dimensions, for an overall size of 33 cm2, including a visual comparison to the size of a credit card.

FIG. 12B illustrates antenna input impedance at an interface with the WuRx circuit, closely matching with the simulated response, with a resonance at 850 MHz, an input resistance at resonance 11.5Ω, a radiation quality factor Qr=10, and a simulated efficiency of 83%, leading to 2 Ω ohmic resistance and 9.5 Ω radiation resistance.

FIG. 12C illustrates a radiation pattern test setup performed in anechoic chamber. A reference horn antenna with 10 dBi gain is used in a two-port response characterization. The antenna under test is excited at resonance and an automatic angle sweep on the yaw axis is performed thanks to a motorized positioner.

FIG. 12D illustrates extrapolated antenna gain as a function of yaw angle, reaching a maximum of 2 dBi in excellent agreement with EM simulations shown in FIG. 9A.

FIG. 13A illustrates a 3D model of a MEMS resonator cavity, composed of a stack of 80 nm Pt bottom metal layer, a 1 μm sputtered AlN film, and a 120 nm Al top metal layer.

FIG. 13B illustrates a Scanning Electrode Microscope picture of the MEMS resonator cavity of FIG. 12A.

FIG. 13C illustrates a RF measurement of input impedance of the FBAR resonator, showing the fitted parameter according to the MBVD resonator model.

FIG. 14A illustrates RF input impedance measurements for comparison between an unmatched WuRx and a MEMS-matched WuRx terminated by 50 Ω source, wherein the matching MEMS includes an in-house fabricated FBAR resonator as described herein. The MEMS-matched WuRx PCB shows resonant-antiresonant response, with an input resistance at resonance approaching the Rm of the resonator.

FIG. 14B illustrates DC rectification sensitivity measurements for comparison between the unmatched WuRx and the MEMS-matched WuRx terminated by the 50Ω source. The MEMS-matched WuRx shows a 12 dB higher DC rectification sensitivity for the same circuitry when excited with a −36 dBm continuous wave at resonance.

FIG. 14C illustrates a designed PCB with discrete SMD components and the MEMS chip wire-bonded to the circuit interface for the MEMS-matched WuRx.

FIG. 15A illustrates a WuRx prototype composed of a custom low Rant antenna (LRA), connected to the WuRx board of FIG. 13C (in the inset, the hybridly integrated FBAR chip via gold wire bonds).

FIG. 15B illustrates a communication link set up in anechoic chamber, with an omnidirectional TX antenna fed with an on-off key (OOK) signal, the WuRx placed 3.7 m away, and an auxiliary antenna to monitor Rx power.

FIG. 15C illustrates DC rectified voltage at resonance for various RF power, respectively for the unmatched WuRx, for the 50Ω RF source WuRx, and for the WuRx excited with the LRA, resulting in 11 dB extra sensitivity with respect to the 50Ω counterpart.

FIG. 15D illustrates Packet Error Rate (PER) for an OOK modulation at 817 MHz carrier with 1 kHz bitrate. The three boards achieved PER=0 for thresholds of −40 dBm, −48 dBm and −61 dBm, respectively.

FIG. 15E illustrates PER Sensitivity to blocker signals for the LRA WuRx. At ±20 MHz from 817 MHz 14 dB and 23 dB rejection is measured.

FIG. 16 illustrates a zero-energy receiver (ZE Rx) architecture including a multi-port antenna, an energy harvester branch, an information receiver branch, and a rechargeable battery.

FIG. 17A illustrates a manufactured exemplary over-the-air energy harvester with a quarter US dollar for size comparison. The system includes a low-impedance antenna, a MEMS-based matching network, two antiparallel Schottky diodes Cx(V) (Model: Onsemi® SBX201C), two capacitors (Cd=120 pF), and two resistances (Rd=5 kΩ. The MEMS-based matching network is connected to the circuit board via wire-bonding.

FIG. 17B illustrates a circuit schematic representation of the system of FIG. 17A. The antiparallel diode acts as a rectifier to convert RF power to DC, while Cd and Rd are in place as a sample and hold circuit. Rload represents the load resistance and, for the case under investigation, is located off-board.

FIG. 18A illustrates a schematic of the implemented single-dipole meandered antenna. The metal plane is sized to provide a strong ground for the antenna and mimic the presence of a second dipole while breaking the system's symmetry.

FIG. 18B illustrates a simulated radiation pattern for the energy harvester of FIG. 17A.

FIG. 18C illustrates a comparison between the simulated and the measured antenna impedance response (Z) for the energy harvester of FIG. 17A. The antenna operates around 800 MHz and its minimum impedance is 11Ω.

FIG. 18D illustrates a microscope image of an in-house fabricated aluminum nitride MEMS film bulk acoustic resonator (FBAR).

FIG. 18E illustrates a measured admittance response of the FBAR implemented for the energy harvester of FIG. 17A.

FIG. 19A illustrates an experimental setup including an RF generator and amplifier.

FIG. 19B illustrates an experimental setup transmitting directional, high-gain, broad-band antenna mounted on a tripod.

FIG. 19C illustrates an experimental setup including the energy harvester of FIG. 17A located 0.5 m from the antenna. A manually tunable Z box is used as a load resistance (Rload) to calculate the rectified power. The voltage absorbed by Z_{load} is measured with a digital multimeter.

FIG. 20A illustrates a measured load resistance of the energy harvester of FIG. 17A.

FIG. 20B illustrates a measured voltage (Vload) of the energy harvester of FIG. 17A.

FIG. 20C illustrates a measured power absorbed by Z_{load} when implementing the MEMS FBAR as matching network (MN) of the energy harvester of FIG. 17A. The circuit implementing the MEMS showcases a 8× improvement in harvested power.

FIG. 21A illustrates a measured load resistance of the energy harvester of FIG. 17A.

FIG. 21B illustrates a measured voltage (V_{load}) of the energy harvester of FIG. 17A.

FIG. 21C illustrates a measured power absorbed by Z_{load} of the energy harvester of FIG. 17A without the MEMS.

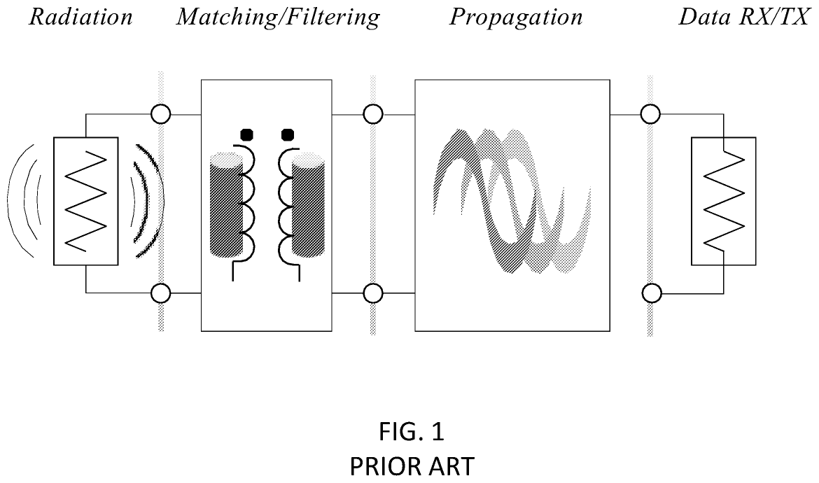

### DESCRIPTION

Provided herein are wake-up receiver (WuRx) antennae for use, for example, in WuRx architectures requiring extremely low-power of operation (e.g., in remote sensor networks such as IoT nodes). The resulting antennae are capable of increasing the passive voltage RF amplification when interfaced with a matching network which ultimately results in an improved node's sensitivity to RF signals. In the proposed methodology, the antenna input impedance can be strategically designed with low radiation resistance. In this context, de-embedding techniques and their effectiveness are described

The WuRx antennae and methods provided herein can beneficially add an extra 10 dB to 20 dB passive voltage gain to the transmitter (Tx) and receiver (Rx) chain of a WuRx at no cost in terms of power consumption. This is borne out by measured results, described below, of a compact PCB antenna fabricated for this purpose. A 2 dB antenna gain is measured on a 11 W antenna operating at 850 MHz. Thanks to this antenna design, an RF sensitivity boost of 13 dB leading to −61 dBm minimum detectable input power is demonstrated in a simple WuRx design.

W_{U}R_{X} Antennae in General

WuRx antennae can be treated as sensors of electromagnetic signals, which carry the information in a wireless communication system. Using a system-level approach, application-specific performances are improved by proper antenna design.

An over-the-air radio frequency (RF) receiver (Rx) system with improved sensitivity is provided having a novel antenna design methodology. In particular, an Rx antenna with a resonant input impedance significantly lower than the one used in conventional RF systems (50 Ohms) is provided. This antenna design methodology is suitable for novel Rx architectures known as Wake-Up Receivers (WuRx). WuRx are drawing increasing attention, with large coverage in academic literature, for their ultra-low power and asynchronous operation (i.e., they can turn themselves ON only when triggered by unique tags, with standby power consumption in the nano Watt range). In WuRx, passive matching networks (MNs) are required to enhance signal sensitivity and to provide filtering capability to the Rx node without increasing power consumption. In this context, MNs provide a passive gain that is approximately given by the ratio between the impedance of the Rx load and the Rx antenna, therefore an antenna design with low impedance is highly beneficial in WuRx. While at the present moment most efforts lie in designing high impedance Rx loads, Rx antennae have been presumed to require a conventional 50 Ohm design. This presumption has led to overlooking of the antenna design space as an opportunity to provide further passive gain.

In this disclosure those presumptions are challenged to develop a different WuRx front end, which, as described herein, has led to the successful deployment of low impedance antennas in WuRx, showing a 4× improvement in system sensitivity with respect to a conventional 50 Ohm antenna system. This disclosure highlights a number of factors used to obtain large passive voltage amplification by co-designing matching networks and RF antennas to systematically improve WuRx performance. Through this work, substantial improvement of front end voltage amplification is achieved by lifting the limiting factors of each component via component co-design.

With that context, an antenna design capable of increasing Rx sensitivity by displaying low impedance at resonance with respect to the conventional 50 Ohm in a WuRx architecture is provided. The design was tested using specific test configurations, some of which are described and depicted herein. For example, in one test configuration the WuRx is made of a high impedance RF rectifier, interfaced with the antenna via a current-type resonator, so to provide frequency selectivity, as well as resonant passive voltage amplification. The test configuration includes a meandered dipole antenna is designed at 850 MHz on a Printed Circuit Board to demonstrate the excess sensitivity. The first electro-magnetic antenna mode can achieve high efficiency (˜85%) and compact form factor (70×40 mm). At the same time, meandered dipoles exhibit low impedance, which is suitable for this application, whereas detrimental for conventional 50 Ohm systems. The antenna is then connected to a Micro Electro Mechanical System (MEMS) piezoelectric resonator. However, it will be apparent in view of this disclosure that low impedance RF antennas as described herein can be achieved regardless of chosen resonator technology. The circuit so composed is finally interfaced with a commercial off-the-shelf RF rectifier, and results obtained with custom antenna are compared with 50 Ohm feed in an anechoic chamber. The net result is that this configuration increases passive gain by reducing electrical loading on the resonant tank (i.e. resulting to an overall increase of loaded quality factor), provided a resonator technology with sufficiently high quality factor.

### Underlying Assumptions and Analysis

The design to be applied to the antenna, as optimized RF transducers, to provide large gain in compact form factor resonant WuRx is described herein. These novel designs ultimately result in relaxed link budget for IoT nodes since an enhanced WuRx sensitivity can directly translate into lower Tx power or equivalently higher communication range and longer nodes' lifetime.

### Passive RF Network Analysis

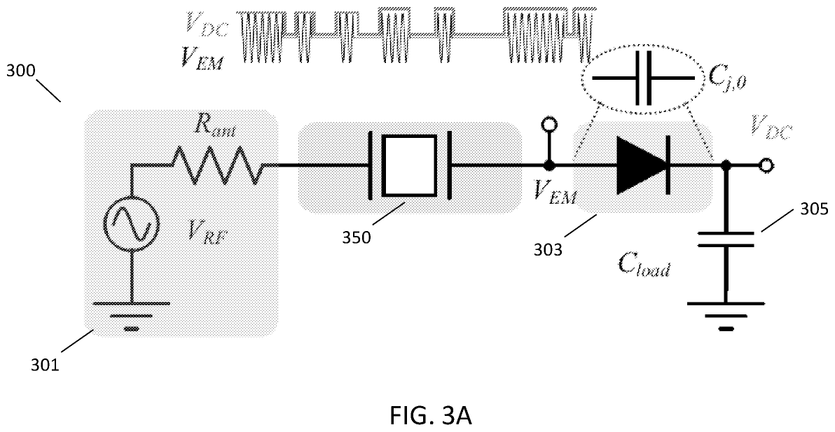

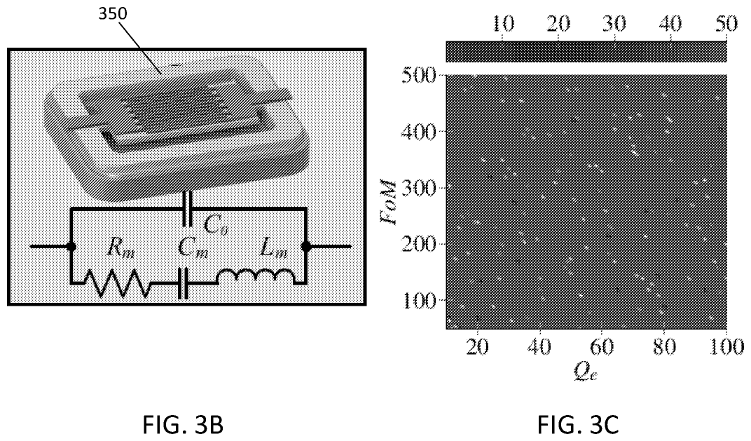

A rudimentary electrical model of a WuRx passive front-end 300 including RF receiving circuitry 301 (e.g., an antenna) is illustrated in FIG. 3A. This model is fundamentally different from conventional Rx equivalent circuits: conventional input stages, such as Low Noise Amplifiers (LNA), are designed with power-hungry transistor stages that typically exhibit a real impedance, that needs to be power-matched to the antenna impedance for maximum power transfer. The techniques discussed as follow strictly apply to IoT WuRx receivers that typically exhibit high capacitive impedance, and are not meant to be generalized to conventional RF receivers.

For low-power RF signals, the rectifier network 303 is represented as the unbiased junction capacitance Cj,0 of a diode, as shown in FIG. 3A, which is the simplest representation of a passive RF rectifier. Above a voltage threshold Vth, the envelope of the RF output voltage VEM in FIG. 3A is demodulated at the circuit output (VDC), where it is held by C_{load} 305 and it is therefore available for further low-power signal processing. The threshold Vth is limited by the chosen rectifier architecture and technology. Note that despite a diode rectifier being shown in the schematic in FIG. 3A, various alternatives have been proposed which are all functionally equivalent to the linearized Cj,0 model. The nonlinear dynamics of this network depend on the rectifier technology in use and a detailed circuit analysis can be performed for diode rectifiers.

The linearized capacitor model does not take into account the rectifiers' nonlinearity, therefore it cannot predict demodulation efficiency and it is therefore valid for the input RF voltage VRF<<Vth. Despite its simplicity, this linearized model conveys enough information to determine the resonant small signal voltage gain, which is the focus of this work.

A strategy to boost V_{EM} in a WuRx with passive components is based on resonance: for this class of Rx circuits, components such as inductors or MEMS resonators 350 (FIG. 3B) are referred to as matching networks, even though there is no power matching involved and they are effectively used to resonate out a capacitive impedance rather than transforming it in a classical sense. When using a one-port matching component, the voltage gain at resonance at the IC input Gv can be written as:

$${G}_{v} = \vert \frac{{V}_{E M}}{{V}_{R F}} \vert \approx \frac{{X}_{c}}{{R}_{ant} + {R}_{match} + {R}_{diss}} \qquad ( 1 )$$

where Xc is the reactance associated to Cj,0, R_{match} the ohmic loss due to the matching network and R_{diss} the ohmic loss due to the antenna. Eq. (1) holds as long as Cload>>Cj,0. When a MEMS resonator 350 is used as a series matching network (FIG. 3C), the MEMS equivalent inductance is used to resonate Cj,

Starting from the equivalent electrical model for the MEMS resonator, known as Butterworth-Van-Dyke (BVD) model (in the inset of FIG. 3B), it is possible to derive Gv as a function Figure of Merit

$$FoM = {k}_{t}^{2} {Q}_{m}$$

of the MEMS resonator 350, where

$${k}_{t}^{2}$$

is the resonator coupling coefficient (representing the electro-acoustic energy transduction) and Qm is the mechanical quality factor (representing the ratio between energy loss and energy stored per cycle at resonance). For this network, an external quality factor Qe can be written as:

$${Q}_{e} = \frac{{X}_{c}}{{R}_{ant}} \qquad ( 2 )$$

So that, for a sufficiently high Qm, Gv can be simplified as:

$${G}_{v} \approx \frac{{Q}_{e}}{1 + {k}_{p} \frac{{Q}_{e}}{FoM} + \frac{1 - {η}_{ant}}{{η}_{ant}}} \qquad ( 3 )$$

where ηₐₙₜ represents the antenna efficiency, and kₚ is a dimensionless parameter, function of C_{j,0},

$${k}_{t}^{2}$$

and the MEMS resonator actuation capacitance C₀. kₚ is a dimensionless factor ranging between 1 and 4, and it can be minimized by proper MEMS resonator sizing. In general, it is not possible to express kₚ in closed form, thus a more thorough discussion with respect to kₚ is omitted here.

Projected gain Gv achieved with MEMS technology is obtained via SPICE simulations in FIG. 3C, confirming the trends analytically derived in Eq. (3).

From this discussion, Gv≈Qe as long as FoM/kₚ>>Qe.

### Design Methodologies

This section introduces the design methodologies investigated at a preliminary simulation stage to devise the low-impedance antennas. Moreover, the challenges posed by non-50Ω antenna measurements are discussed and a suitable de-embedding technique is described to address those challenges.

In the schematic representations of FIGS. 4A-4B, x is the [symbol] dimension of the antenna, and it is assumed that the current/voltage feed point terminal is at x=0. A current-mode antenna (FIG. 4A) displays a current maximum at the feed point. Similarly, a voltage-mode antenna (FIG. 4B displays a voltage maximum at feed point, x=0.

The current/voltage spatial distribution corresponds respectively to a minimum/maximum of the input impedance at the resonance frequency Fᵣₑₛ, i.e., when the radiating side approaches λ/4, where λ is the EM wavelength. Therefore, it makes sense for the low Rₐₙₜ RF antenna to be excited by a structure that has a fundamental mode corresponding to the current-mode shape as in FIG. 4A.

As widely reported in the literature, a viable option to implement low Rₐₙₜ structures could be implemented using Electrically Small Antennas (ESA).

Crucially for their role in WuRx, ESAs radiation properties are limited by a region known as Chu limit. For an antenna that is contained in a sphere of radius r, the Chu limit sets a relationship between the ratio α=r/λ and their Rₐₙₜ such that, for a small α, it follows that

$${Q}_{ra d} = \frac{{X}_{ant}}{{R}_{ant}} \approx \frac{{π}^{3}}{16 {α}^{3}}$$

where Xₐₙₜ is the reactive part of the antenna input impedance. Differently from resonant antennas, ESA displays, at the frequency of interest, an impedance that is mostly reactive (Xₐₙₜ), i.e., a small Rₐₙₜ.

These structures are excited well below resonance so that they can achieve smaller form factors. Even though a WuRx would benefit, in theory, by the extremely small Rₐₙₜ, the performance of these antennas is always limited by the poor directivity and the losses due to the matching components required to compensate for the large Xₐₙₜ. As an example, an ESA with α=0.1 has a radiation quality factor Q_{rad} 2000 and a passive matching component has to be used to resonate out Xₐₙₜ in practice. Any real component used to accomplish this task will have a much lower quality factor, Qu. As a net result, most of the delivered power is dissipated as ohmic loss resulting in a very low antenna efficiency ηₐₙₜ, which eventually leads to poor passive voltage amplification.

For these reasons, an open-end, center-fed, dipole-like, resonant structure was selected for the test configurations used in connection with the WuRx framework described herein.

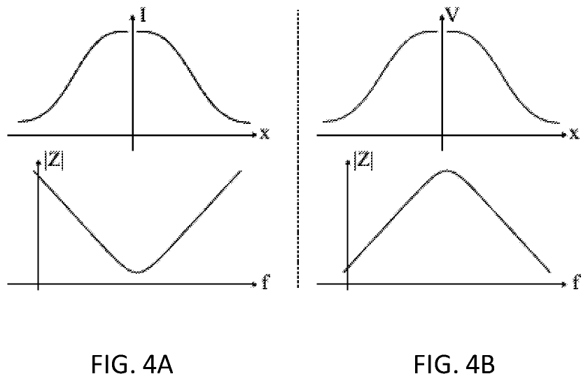

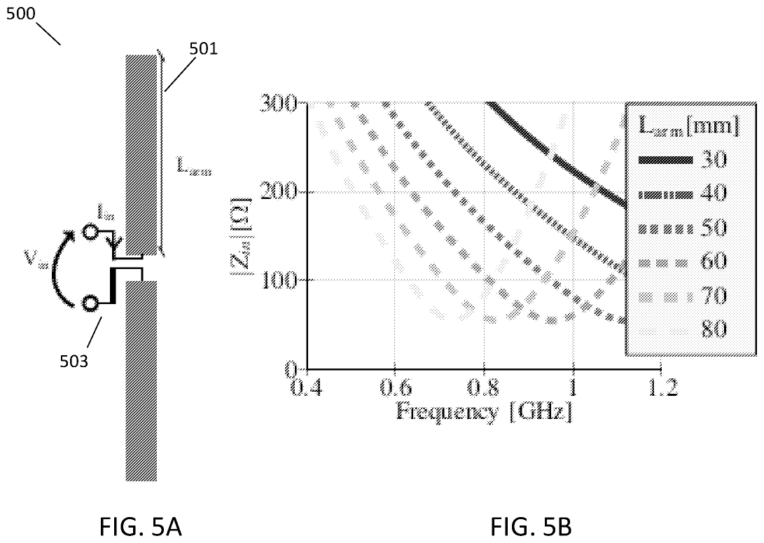

Throughout the rest of the paper, ADS® Momentum engine is used, as an electro-magnetic simulation platform suitable for planar antennas, to evaluate the WuRx antenna's input impedance and radiation parameters. To model the EM environment, a reference substrate composed of a 16 mm thick FR4 layer with εᵣ=4.3 sandwiched between two 17 μm thick Cu layers representing top and bottom PCB metal layers, is used as shown in FIGS. 5A, 6A, and 7A.

Conventional differential dipole structures 500, as the example shown in FIG. 5A, generally include two linear arms 501 and an antenna excitation port 503. Considering such a structure 500, a well-known closed-form expression for Rₐₙₜ is available resulting in approximately 73Ω at resonance. The antenna's input impedance is presented in FIG. 5B where a frequency-independent minimum resistance around the aforementioned theoretical value is shown at resonance frequency for various lengths, Lₐᵣₘ, of the dipole's arm. Therefore, two 70 mm long arms are required to operate in the 800 MHz range, according to FIG. 5B.

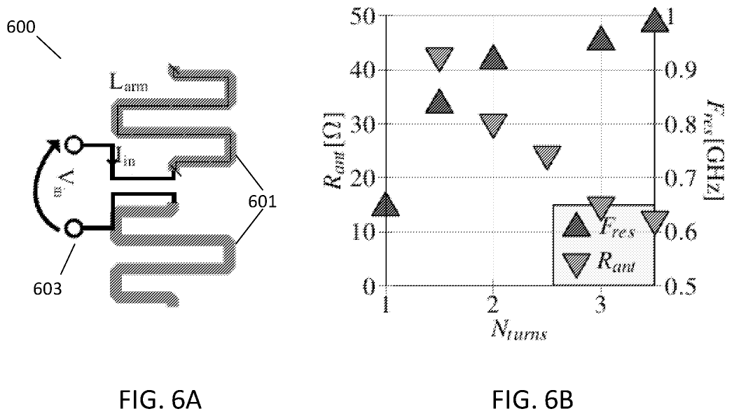

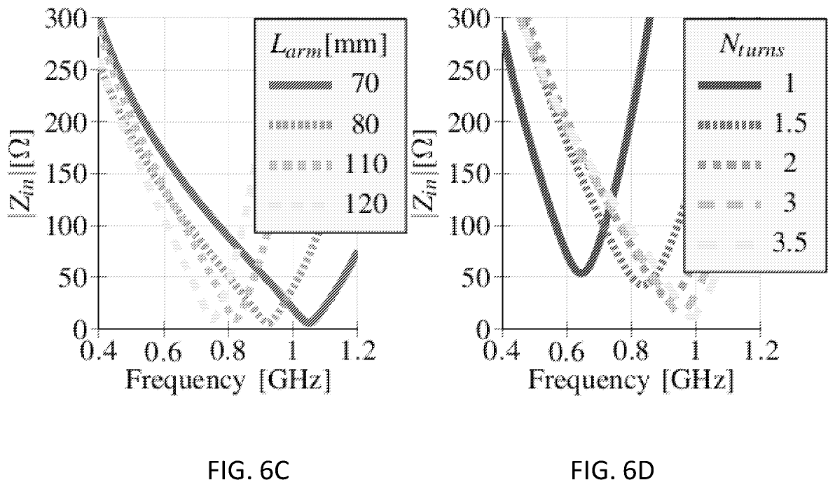

To keep the overall length Lₐᵣₘ within a more space-efficient [symbol] design and for ease of realization on PCB, a folded structure known as meander antenna 600 (shown in FIG. 6A) is often proposed. Such antennae typically include two arms 601, each having a number of turns formed therein, and an excitation port 603. When compared to a conventional dipole antenna 500, a meander antenna makes inherently more efficient use of the top metal layer, resulting in smaller form-factors. In general, spatial efficiency can be determined as a function of the number of meanders Nₜᵤᵣₙₛ.

For conventional RF systems, the use of meandered antennas presents significant challenges in terms of radiation efficiency and bandwidth. In fact, as shown in FIG. 6B-6D, antenna input impedance is significantly affected by Nₜᵤᵣₙₛ.

Simulation results in FIG. 6C show that the antenna resonance Fres scales inversely with respect to the arm length Larm as expected for a dipole-like antenna.

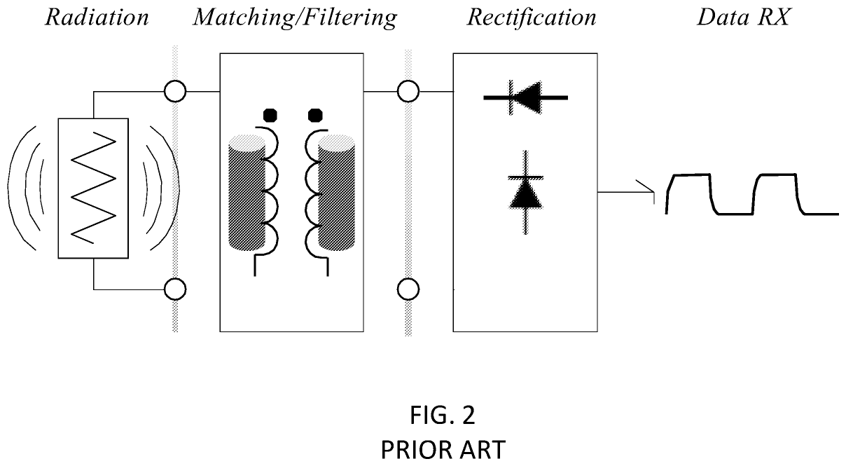

The radiation resistance Rant is mostly independent of Larm at the resonance frequency, and instead, it decreases monotonically with Nturns as highlighted in FIG. 2(b). The minimum radiation resistance, Rant≈10Ω realized in FIG. 2C is obtained for Nturns=3, sufficient for this work. More generally, one of skill in the art will understand that antenna response is a function of the number of meanders Nturns.

So far, the antenna designs presented are driven by purely differential currents. Fully differential systems consume at least twice as much current as their single-ended counterparts. Therefore, it would be beneficial to provide a single-ended termination for WuRx antennas. While single-ended RF signal excitation is technically possible on this passive differential antennas, this causes an inherent unbalance in the antenna excitation, ultimately resulting in a significant degradation of antenna gain in practice.

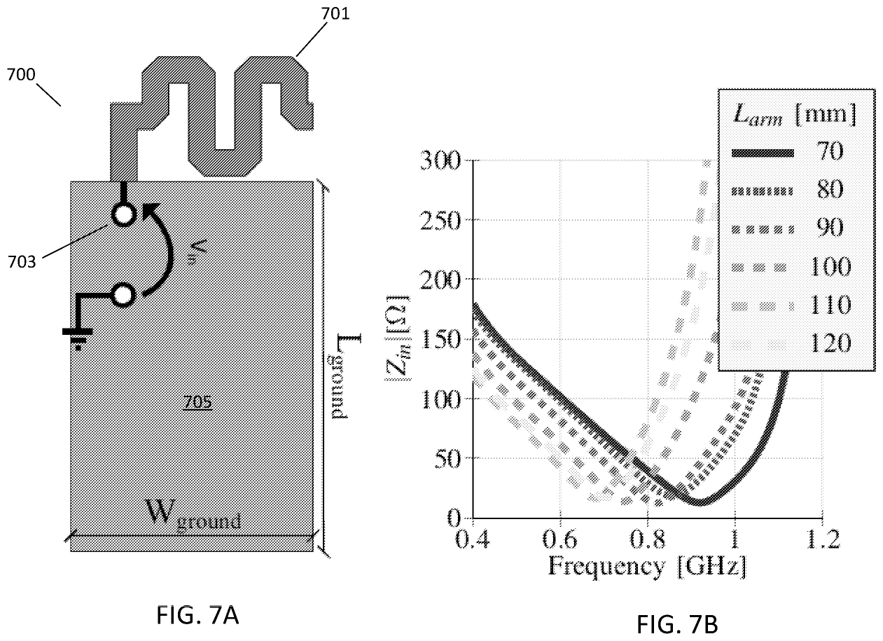

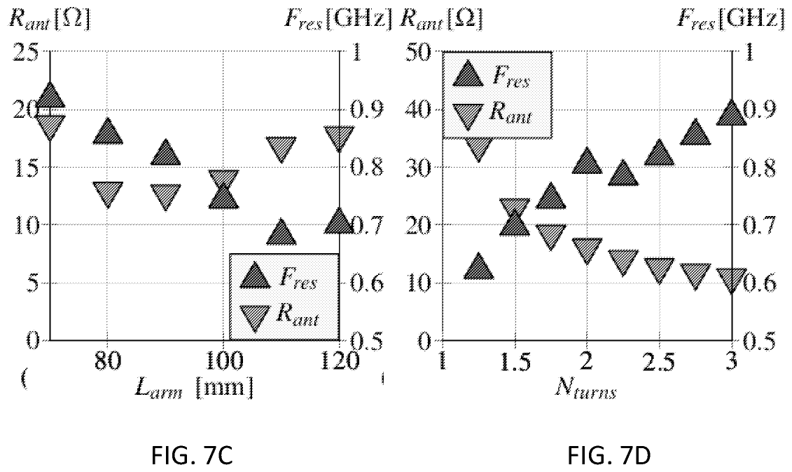

For this reason, a half-meandered structure 700, as shown in FIG. 7A, was ultimately chosen for this application. The half-meandered structure 700 generally includes a single meandered arm 701 having a plurality of turns formed therein and an excitation port 703, leveraging the bottom metal ground pour 705 as a path for return RF currents, resulting in an antenna excitation that can include a ground connection, breaking the symmetry of the differential dipole and compatible with the single-ended grounded meander antenna 700. As a result, any electro-magnetic energy storage in the fully differential meander is halved and the antenna efficiency is higher than the differential meander dipole.

The single-ended grounded meander antenna 700, shows similar trends as the differential one 600, as evident in FIGS. 7B & 7D. In particular, Nturns has a similar impact on Rant (shown in FIGS. 6B & 6D) providing an easy way to obtain low Rant. Similarly, Fres is mainly dependent on both Larm and only weakly dependent on Nturns as shown in FIGS. 7C & 7D. While efficiency ηant in the differential meander results in about 80% due to the ohmic path required to implement a λ/4 stub, for the single-ended meandered design, an ηant above 85% is obtained in simulations, since only one arm contributes to the ohmic losses, i.e., due to being half of the differential counterpart.

### Finite Ground and Antenna Gain Bandwidth

While the ground plane 705 in FIG. 7A provides a return path for the RF currents harvested by the meander, it does not prevent radiation from/to the back of the PCB plane to be harvested/transmitted.

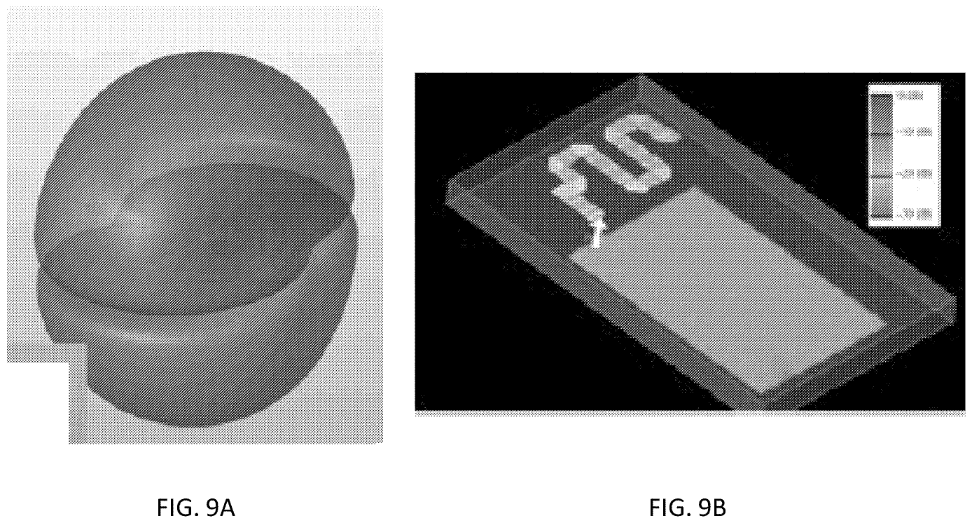

In fact, as shown in FIGS. 9A, radiation pattern (directivity) is symmetric around the PCB plane. Moreover, uniform dipole-like radiation pattern is achieved in this structure, so that omnidirectional functionality can be achieved. For completeness, the current pattern distribution (FIG. 9B) numerically confirms that the current has a maximum corresponding to the RF input terminal. A slight elongation in the axis direction (Y) parallel to the dipole folding is observed in the EM Momentum engine.

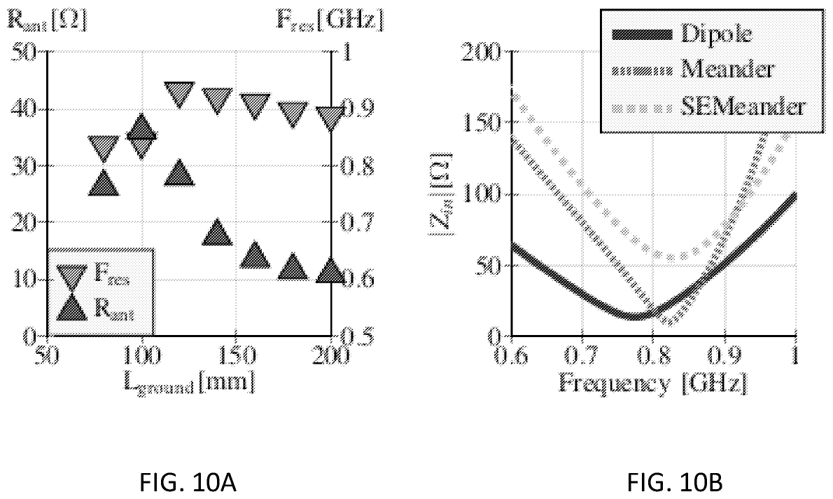

In FIG. 10A, the impact of the finite-ground is numerically evaluated where radiation resistance and resonance frequency deviates from the results obtained in FIGS. 7C & 7D as the groundside falls below 200 mm, approximately twice the total length of the meander.

However, due to the omnidirectional nature of the dipole-mode, the directivity is almost consistently kept around 2.5 dB across all the numerical investigations considered, consistent with the radiation pattern in FIG. 9A.

While an efficiency above 90% is simulated for the differential dipole in FIG. 5A, efficiency in the differential meander drops to about 80% due to effectively longer ohmic path required to implement a λ/4 stub. For the single-ended meandered design, on the other hand, an efficiency above 85% is obtained via simulations because only one arm contributes to the ohmic losses, due to being half of the differential counterpart.

As a side note, meandered designs have admittedly lower usable bandwidth than the dipole counterparts (FIG. 10B). The magnetic field produced in the meandered sections is the vector sum of multiple half-loop current contributions. Consequently, Q_{rad} is increased from 16 to 45 in simulated results. However, this effect is mitigated when the ground plane is introduced, and the single ended meander antenna displays a Q_{rad}≈10.

### De-Embedding Technique

As briefly discussed in the introduction, part of the underlying assumption of WuRx is the need for short interconnects between Rx and antenna terminals. Under this assumption, formally described by a condition on maximum distance ΔL≤λ/16 between antenna and IC terminal, propagation effects such as impedance transformation can be neglected so that the low impedance source can be effectively exploited by the IoT node. While the signal propagation in a conventional 50Ω system does not represent an issue, as it results in a small RF signal delay only, practical issues arise in an unmatched system.

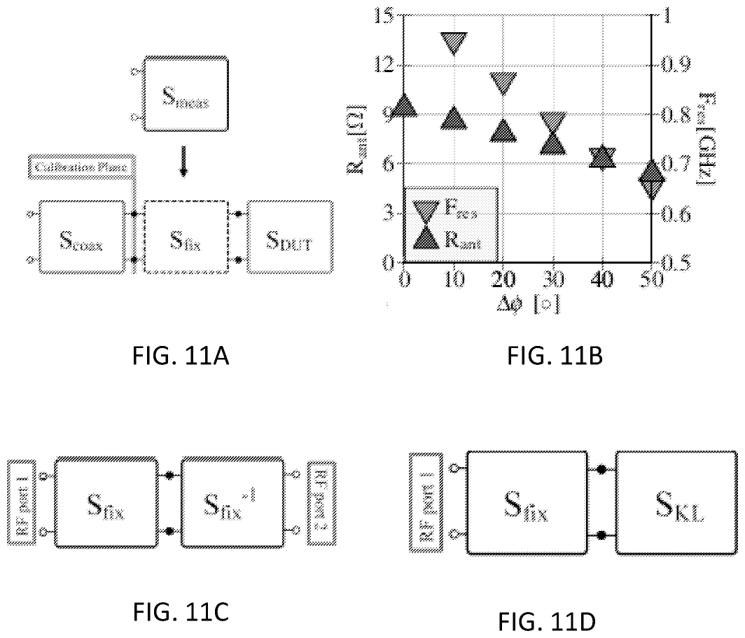

Consider as an example the test setup schematically represented in FIG. 11A. When measuring the input impedance of an RF network (Sₘₑₐₛ), the coaxial cable response (S_{coax}) is calibrated so that the scattering parameters (S_{DUT}) of the device under test (DUT) can be measured without taking into account loss, mismatch and delay introduced by the cable. However, most calibration scenarios do not take into account the impact of device fixtures S_{f}, required every time the DUT does not mate with the coaxial cable, so that a microwave connector needs to be used to transition the RF wave from the coaxial cable's medium to the DUT's medium, i.e., the PCB substrate of the antenna.

Given the ubiquitous use of components with 50Ω characteristic impedance, most fixtures like connectors and PCB traces are designed to match to 50Ω wave impedance. As the proposed antenna design significantly deviates from the 50 Ω design condition, even for very small phase delays, Δφ, significant impedance transformation occurs (as shown in FIG. 10-(b)) where both Rₐₙₜ and Fᵣₑₛ are subject to significant drift from their predicted values.

A strategy to de-embed fixtures is proposed here, starting by an auxiliary measurement of the unwanted fixture S_{f} cascaded to its mirrored implementation

$$( {S}_{f}^{- 1} )$$

(FIG. 11C). The network response obtained by

$${S}_{f} = \begin{matrix}{S}_{f} & {S}_{f}^{- 1}\end{matrix}$$

is symmetric, so out of the three unknown S-parameters S_{f,11}, S_{f,21}, S_{f,22}, two equations can be cast.

To obtain a relevant third equation to solve the system, a one-port measurement S_{hf} of a known load of impedance Z_{KL} terminating the fixture (see FIG. 11D) is provided. In this way, a closed-form solution to the problem can be analytically found with an accuracy that is limited by the accuracy of the Z_{KL} measurement. The system unknowns can then be expressed as:

$${S}_{f , 11} = {S}_{ff , 11} - {S}_{ff , 21} [ 1 - 2 {Z}_{0} \frac{{S}_{ff , 21} - {S}_{ff , 11} + {S}_{hf}}{Δ} ] \qquad ( 4 )$$

$${S}_{f , 21} = - 2 j \sqrt{{S}_{ff , 21} {Z}_{0} {Z}_{K L}} \frac{\sqrt{{( {S}_{ff , 11} - {S}_{hf} )}^{2} + {S}_{f , 21}}}{Δ} \qquad ( 5 )$$

$${S}_{f , 22} = 1 - 2 {Z}_{0} \frac{{S}_{ff , 21} - {S}_{ff , 11} + {S}_{hf}}{Δ} \qquad ( 6 )$$

where Δ, defined in Eq. (7) below, vanishes to zero when Z_{KL} ∞, so that in practice no open-type load can be used as Z_{KL}.

$$Δ = {S}_{hf} ( {Z}_{0} - {Z}_{KL} ) + {S}_{ff , 21} ( {Z}_{0} + {Z}_{KL} ) - {S}_{ff , 11} ( {Z}_{0} - {Z}_{KL} ) \qquad ( 7 )$$

As previously specified, the accuracy of the de-embedding results is limited by the accuracy of Z_{KL} (and therefore S_{KL}). Currently, commercial models of selected passive components substrate-dependent measurements are commonly available up to tens of GHz. The accuracy and effectiveness of such a de-embedding strategy is proved up to 1 GHz as described below.

### Test Configuration

### Integration of MEMS Resonator on WuRx PCBs

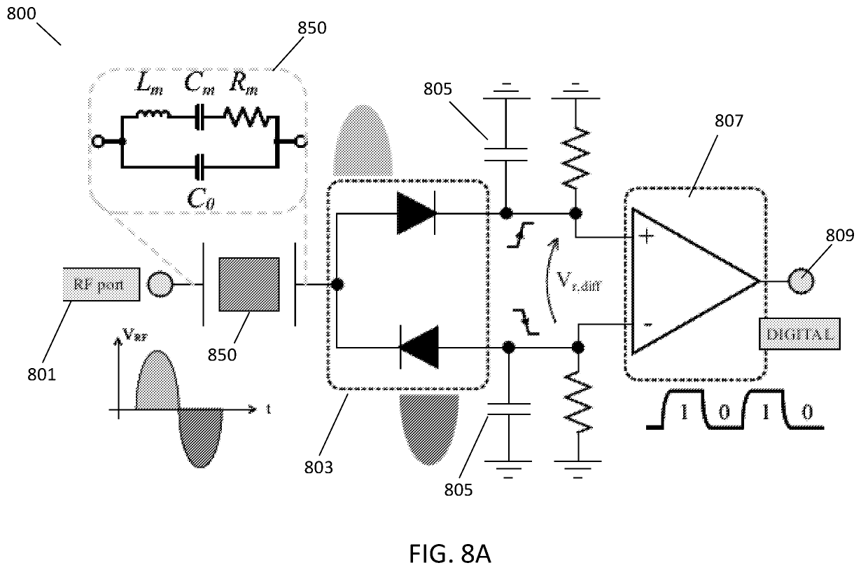

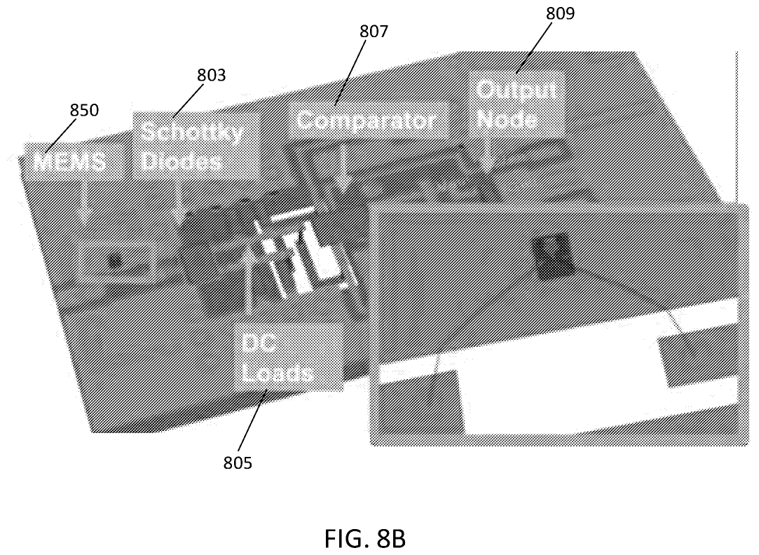

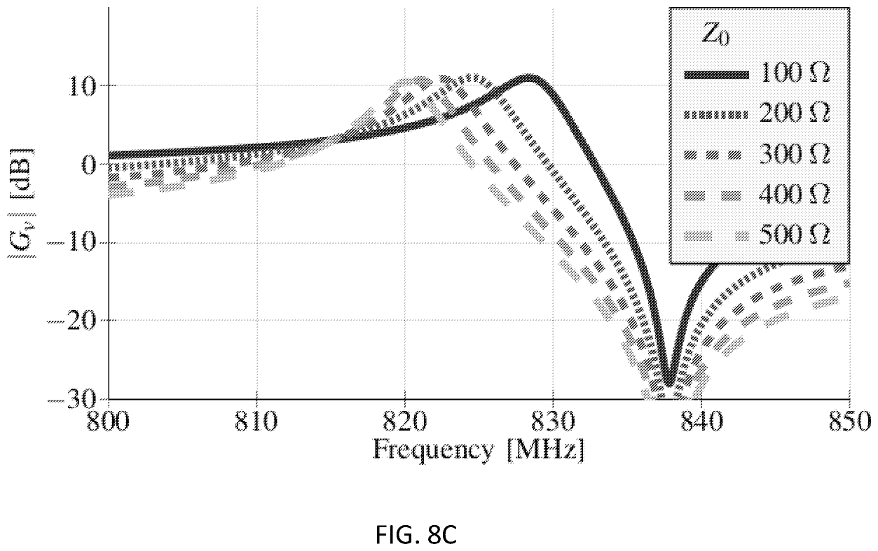

A circuit 800 deploying a complementary RF Schottky diode rectifier 803 (SBX201C from Onsemi®) and a low-power comparator 807 (TS391 from Onsemi®) are chosen to devise a simple WuRx asynchronous architecture 800 (FIG. 8A) to down-convert and digitize the RF signal. The circuit 800 also includes an RF port 801 for receiving the RF signal, one or more DC loads 805, and an output node 809.

This prototype WuRx 800 is implemented via commercially available components and it is intended to benchmark the benefits introduced by the custom RF passives designed in this work, and therefore the obtained power consumption does not exhibit ultra-low power custom IC designs. Rather, it is used as a proof-of-concept design of how passives can augment node sensitivity and selectivity in the presence of RF integration challenges.

One of the tuning knobs required to achieve a high Qe is a high IC input reactance Xc. When operating at RF, every parasitic potentially impacts Xc by either introducing shunt capacitances to ground, or series stray inductance. To factor them in, the effect of wire bonding the MEMS resonator, the PCB traces, as well as packaging parasitics provided by manufacturer are included in a ADS Momentum® co-simulation platform (shown in FIGS. 8B & 8C), capable of capturing EM effects induced by pads, traces, and wire bonds, as well as discrete components simulated from packaged parts.

An operational frequency of 817 MHz is set, falling within the RF range currently covered in some of the most popular IoT node applications, as discussed in Section I. A thin-film bulk-acoustic resonator (FBAR) operating in this frequency range is fabricated in-house and modeled in the EM setup as shown in FIG. 8B (resonator in the inset).

Schematic and Gv simulation results obtained by using the FBAR resonator as a matching network and a back-to-back diode rectifier model are respectively shown in FIGS. 8A & 8C. The low junction capacitance, rated at Cj0=40 fF in the datasheet, would result in a Xc=4.85 kΩ. However, more than 100 fF and 85 fF are introduced by the packaging and SMD pads respectively, resulting in a Xc=420Ω at 817 MHz.

Considering that the simulation reflects conventional test setup for RF components, and therefore obtained by driving the matched stage with a 50 Ω source, an achievable Qe=8.5 is estimated from Eq. (2), and therefore an achievable gain Gv between 4 and 6, depending on kₚ.

Therefore, the EM simulation results in FIGS. 8B & 8C show that in absence of a tight integration process, the upper limit for Xc and therefore Gv is limited by packaging and/or wire bond parasitics, regardless of the resonator Figure of Merit (FoM), differently than for the ideal scenario discussed above.

### Measurements

As described herein, to validate the proposed component and system level approach in a relevant technological platform, antenna performance is simulated and experimentally validated around the 800 MHz carrier frequency, which is targeted by the popular low-power standard LoRa and LoRa WAN protocol.

This section presents measurement results for a case study on antenna design at 850 MHz, reaching Rₐₙₜ=11Ω, which will be demonstrated to be suitable for WuRx applications. Impact of the de-embedding technique on the antenna performance is discussed and matching with the expected performance is demonstrated. A realized antenna gain 2 dB is recorded in an anechoic chamber which shows an excellent match with the simulated results.

Furthermore, a simple WuRx implementation using off-the-shelf components, which are integrated with a conventional antenna and the antenna of novel design, respectively, confirmed the model predicting the excess gain thanks to the novel low impedance antenna design.

### RF Components Characterization

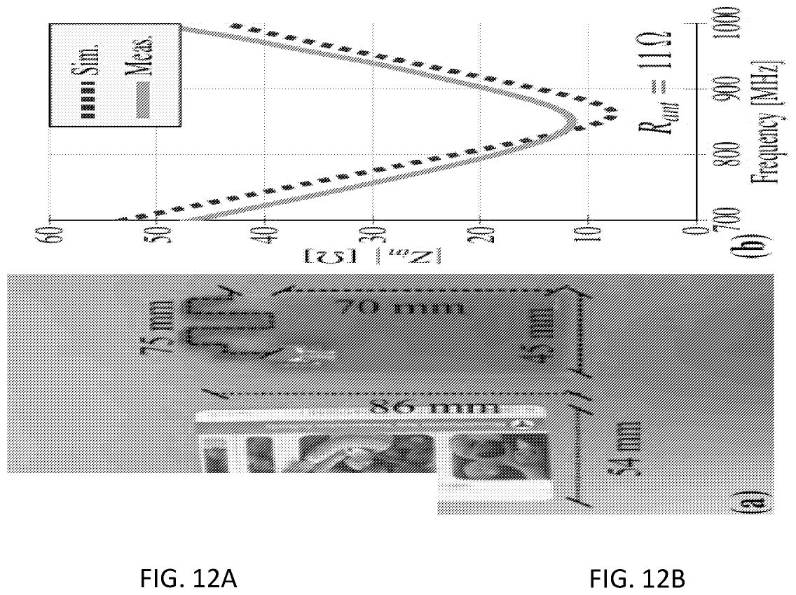

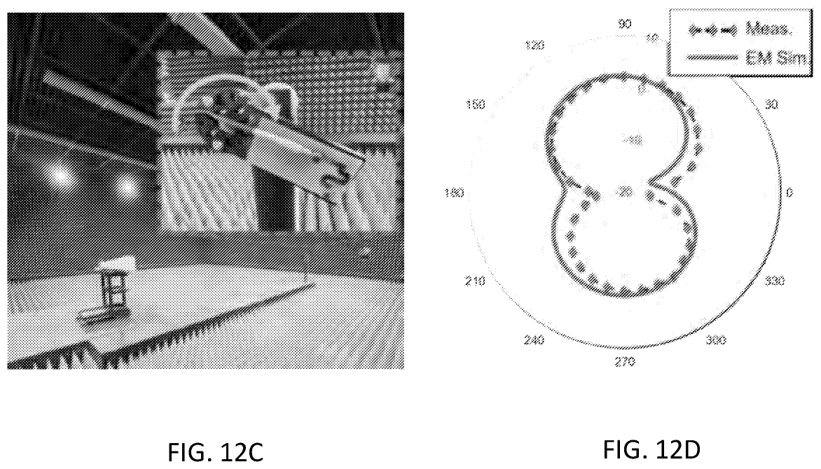

Based on the design guidelines discussed above, a PCB implementation of the proposed single-ended meandered antenna dipole was designed and characterized targeting WuRx communication bands, e.g., 800 MHz to 900 MHz as in LoRa, and a low Rₐₙₜ. FIGS. 12A-12D show the realized PCB antenna along with experimental results, which show good agreement between the EM model and the measured Zin, both in Rant, Fres, and radiation pattern.

A test setup is designed and implemented in the Kostas Research Institute anechoic chamber in Burlington, MA, to investigate the radiation properties of the designed prototype. The DUT's antenna is positioned on an ETS-Lindgren automatic positioner and its yaw rotation axis is swept from 0° to 360°. A reference horn antenna with 10 dBi gain is oriented with its maximum gain direction interjecting the normal of the PCB plane, as shown in FIG. 12C.

The experimental setup is run by exciting the horn antenna at the de-embedded resonance frequency 850 MHz so to identify the directivity on the XZ cut by rotating the antenna in the yaw axis, as noted in the picture, and recording at the same time the received power, properly scaled to take into account the low radiation resistance Rₐₙₜ.

The antenna system is positioned at a distance of 13 m and, using the Friis equation, the realized antenna gain of the DUT is recorded as a function of the angle. A peak gain of 2 dBi, as shown in FIG. 5(d), closely resembles the predicted directivity of 2.5 dBi and efficiency of 83%.

The frequency response at the antenna interface FIG. 12B is represented via Zᵢₙ rather than a more conventional Su reflection. As the antenna is not matched to 50Ω by design, the conventional Su characterization does not capture meaningful information. In contrast, |Zᵢₙ| highlights a series resonant peak at 850 MHz, showing a 11.5 Ω resonant input resistance. Given the complexity of directly measuring antenna efficiency, antenna efficiency is estimated via the simulated Momentum results. Taking into account FR4 loss tangent and copper finite resistivity, an efficiency of 83% is calculated, so that the overall input resistance can be broken down into a 2 Ω and 9.5 Ω ohmic and radiation resistance, respectively.

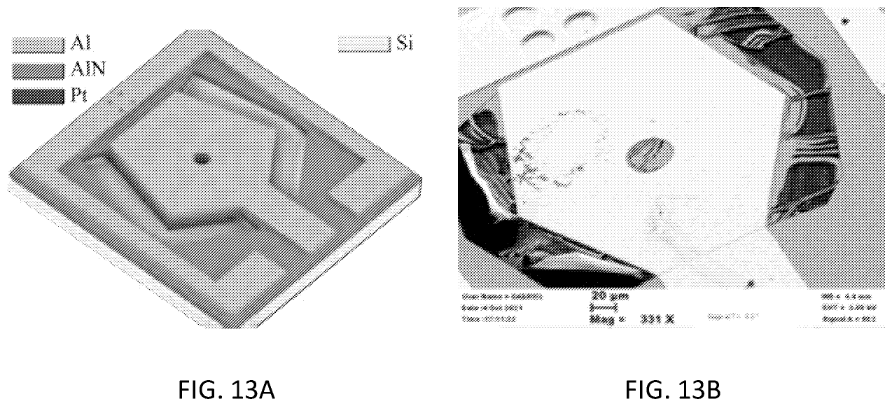

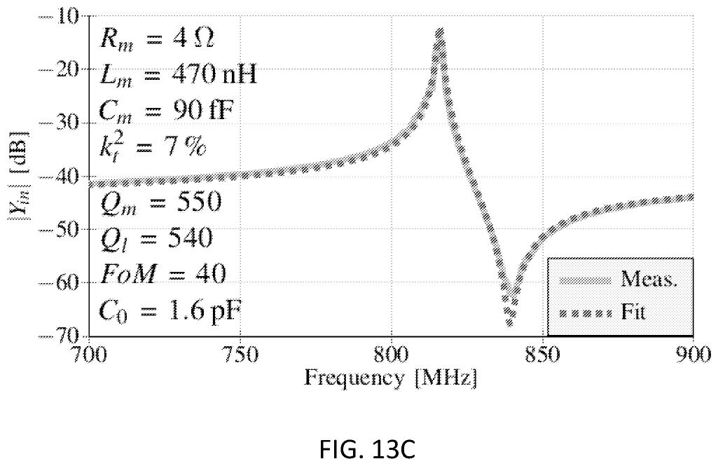

A piezoelectric thin-Film Bulk Acoustic Resonator (FBAR), based on the vertical excitation of squeeze-film mode in a sputtered AlN film sandwiched between a Pt bottom electrode and a Al top electrode, has been fabricated in-house. Processes for fabrication of such FBAR has been described by the inventors in other publications. A cross-section and SEM picture are represented in FIGS. 13A-13C. This particular device showed Q≈550, coupling

$${k}_{t}^{2} = 7 \% ,$$

and a resonance frequency of 817 MHz (FIG. 13C).

### Wake-Up Receiver Measurement

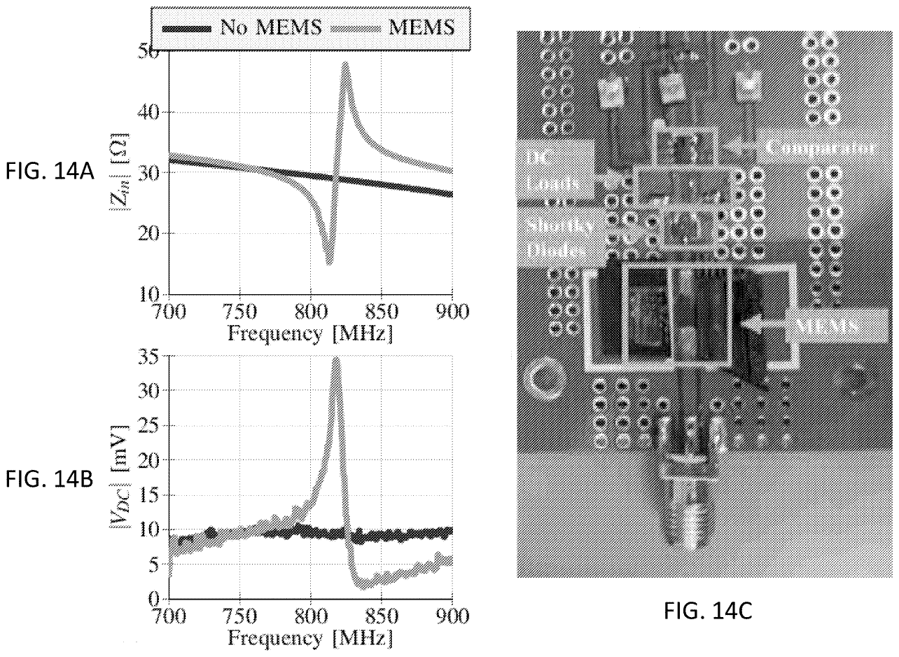

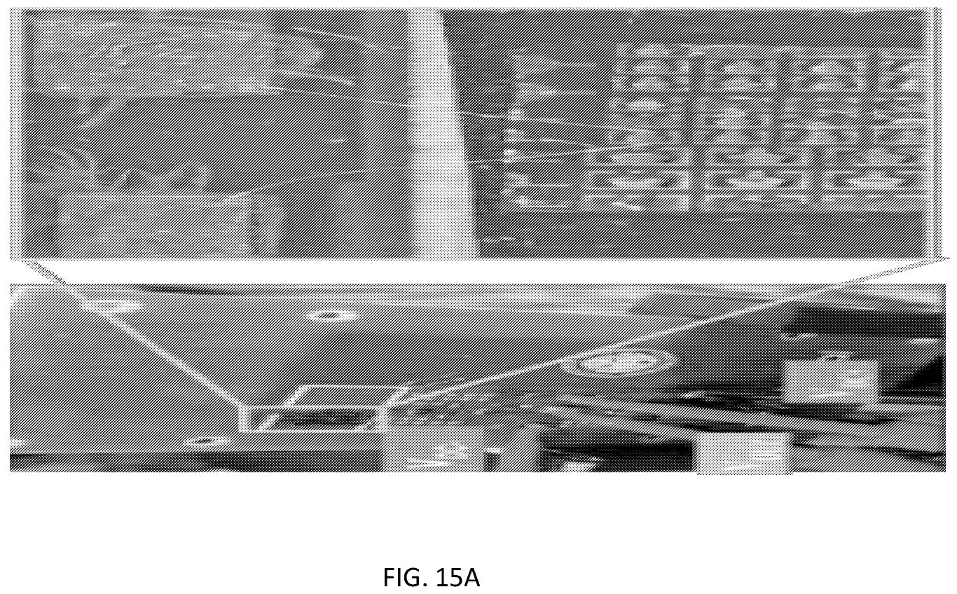

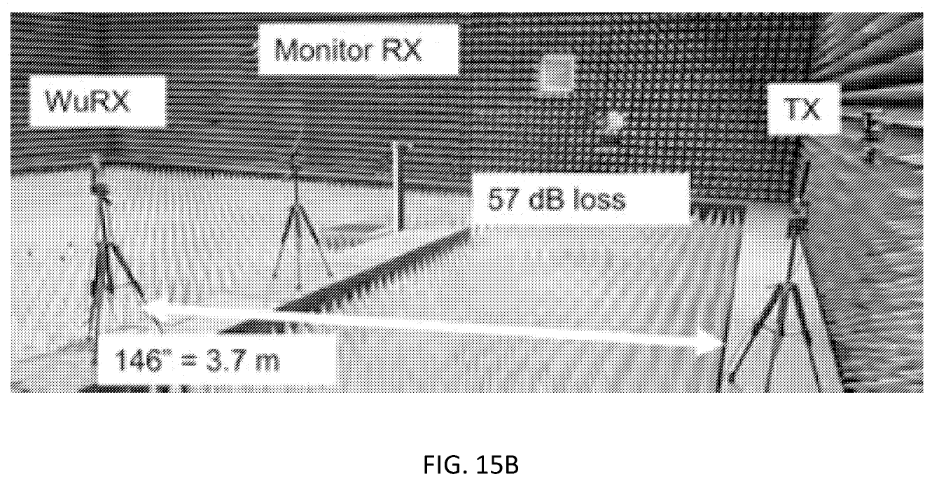

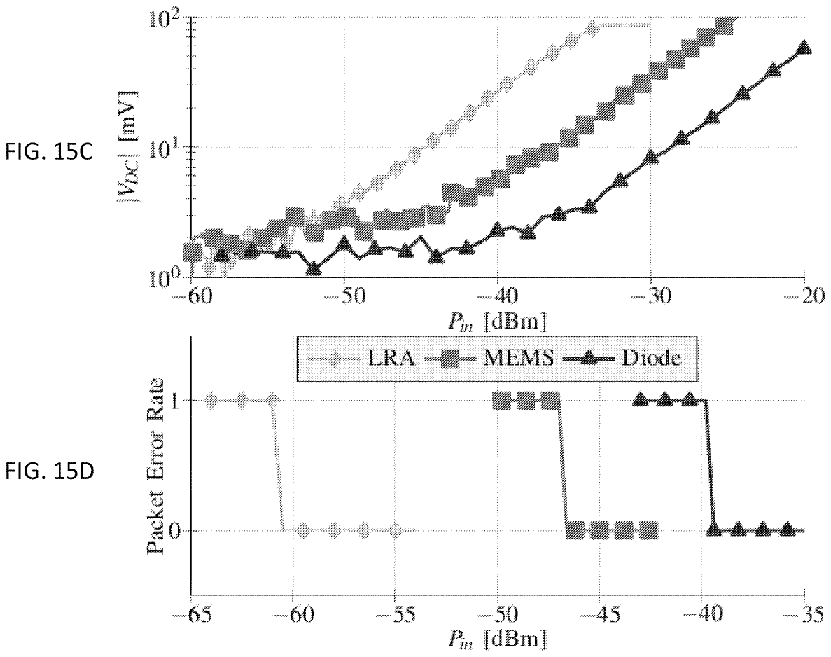

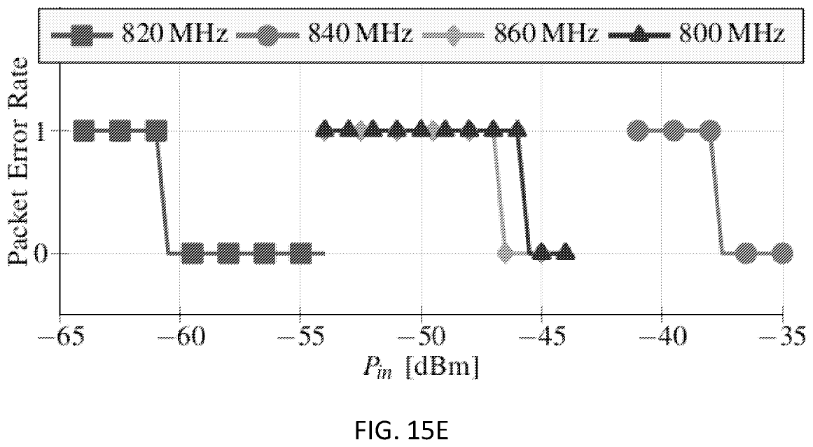

To better highlight the impact of RF termination on the measured Gv, two sets of experiments are presented. In the first scenario (FIGS. 14A-14C) the WuRx is tested with an excitation coming from a 50Ω coaxial cable. In the second scenario (FIGS. 15A-15E), the LRA and WuRx are integrated on the same PCB.

For the first setup, tested in a laboratory environment, an RF continuous wave with variable frequency and power is fed to the front-end via coaxial cable, and the rectified DC voltage VDC is measured at the comparator input, so to compare the rectification sensitivity between the MEMS-matched circuit and the unmatched one. The results are plotted in FIGS. 14A & 14B.

The center frequency of the system, fᵣₑₛ=817 MHz, is found close to the selected MEMS resonant frequency (FIG. 13C), confirming previously observed trends. A board without MEMS is used as a reference, to highlight the relative gain measured on the board with MEMS. The measured gain Gv=4 (12 dB) is in partial agreement with the simulated performance. In this way, a moderate Gv is realized and the other proposed benefits of MEMS matching are experimentally validated. The sharp peak recorded in FIG. 14B is followed by an anti-resonance peak that ensures higher rejection in the near-band, in close agreement with the MBVD resonator model and the measured input impedance (FIG. 14A), resulting in a 23 dB rejection between in-band and out-of-band response.

A second Rx experiment is designed to characterize the custom WuRx-Antenna PCB. The experiment is performed in the KRI anechoic chamber in Burlington, MA (see FIG. 15B, where the WuRx is placed at 3.7 m from Tx and a reference antenna is positioned at the same radial distance to monitor propagation loss of the Tx signal (57 dB).

In this setup, the overall center frequency shifts from the antenna resonance because of the high-Q MEMS resonator, resulting in an overall 817 MHz center frequency. FIG. 15C shows a direct comparison of the sensitivities when both systems are excited by a CW at resonance.

Rectified voltage is plotted against input power at resonance for a 50Ω terminated WuRx and for the LRA WuRx shown in FIG. 15C as well as compared with the unmatched rectifier as well, to emphasize the increased sensitivity at lower input powers. In this experiment, the limit of detection is set by the experimental setup, as no visible DC signal is measured below 50 dBm. A pair of unshielded, untwisted DC probes is used to connect the WuRx board to a DSOX400A Keysight oscilloscope, limiting the detection at around 1 mV with 64 averaged measurements, showing linear-in-dB voltage rectification above the noise floor.

A voltage gain of about 23 dB, 11 dB more than the gain obtained with a 50 Ω source, is measured for the LRA WuRx. The measured gain is compatible with a Qe≈20 and kₚ≈2. Note that Qe is approximately 5 times larger than one realized on the 50Ω source matched with the same resonator, which is consistent with an Rant approximately 5 times smaller than 50Ω. FIGS. 15D & 15E show measured results for the digital packet recovery experiment, verified using actual OOK modulated signals to send information over-the-air. A MATLAB® interface is programmed so that a random sequence of 16 bits, independently generated at each experiment run, is used to modulate the RF carrier as an OOK sequence. The RF carrier is generated using a Tektronix TSG4104A signal generator, suitably amplified, and transmitted over the air in the controlled environment of the anechoic chamber. The WuRx comparator output is monitored by an oscilloscope, triggered by the first bit edge in the Tx section.

An algorithm is used to record the voltage signal reconstructed by the WuRx and compare it with the input bit-stream to determine a packet error rate (PER) for different levels of input power. An input power threshold corresponding to the WuRx sensitivity is then determined.

Because of the relatively high power consumption of the commercial comparator (≈0.75 mW, approximately 0.5 mA at 1.5 V), no bits are lost above the threshold in both setups and therefore PER dropped quickly from 1 to 0 with no error, based on a statistic of 50 consecutive runs.

As shown in FIGS. 15D & 15E, the LRA outperformed the 50Ω source, confirming the 11 dB excess sensitivity measured in the DC rectification experiment, summing to a reported minimum detectable signal of −48 dBm and −61 dBm respectively, at 817 MHz. Note that in this test, the rectifier output is not monitored and therefore the noise introduced by the probes does not affect the results, leading to a much lower noise floor at the comparator input-estimated to be respectively 60 and 25 μVrms with SPICE simulations.

Table I shows performance comparison with other examples in the literature of WuRx deploying MEMS resonators, showing that while this work outperforms WuRx based on AlN resonators thanks to the LRA, higher sensitivities can be achieved by using LNB resonators, opening to very interesting scenarios of high-gain WuRx when the antenna techniques discussed in this work are deployed in conjunction with such high FoM resonators.

TABLE I
RF Passive Voltage Amplification in Selected WuRx Designs

| | | Thin- | Freq. | | Gᵥ |
|---|---|---|---|---|---|
| Design | Source | Film | (MHz) | FoM | [dB] |
| Prior Art 1 | Coax | LNB | 404 | 327 | 22 |
| Prior Art 2 | Coax | LNB | 88 | 157 | 14 |
| Prior Art 3 | Coax | AlN | 59 | 32 | 20 |
| Prior Art 4 | Coax | AlN | 2000 | — | 13 |
| Prior Art 5 | Coax | AlN | 817 | 38 | 12 |
| Instant | Antenna | AlN | 817 | 38 | 23 |
| Application | | | | | |

Moreover, with the integration-aware modeling proposed in this work, the appropriated MEMS technology and RF integration platform can be selected so as to not limit the WuRx performance with parasitic effects when higher and higher RF carriers are considered.

### Energy Harvesting

### Energy Harvesting Background

As explained above, the development of Internet of Things (IoT) technologies has been an area of significant growth and innovation in recent years. In the IoT space, event-driven remote sensor networks are an appealing solution to collect data forming a decentralized, low-power, and low-cost system. These sensors are specifically designed to be left in place for long periods of time without the need for regular maintenance or battery replacement, operating in stand-by mode with nW power consumption, consuming therefore higher power only when triggered by a physical or radio frequency (RF) trigger.

To increase the battery lifetime of these nodes, one of the proposed solutions is the use of energy harvesters (EHs), which are devices that convert ambient energy from sources such as light, vibration, or temperature differences, into electrical energy that powers the sensor. Harvesting energy to drive the circuit consequently reduces the need for battery replacement, increasing the sensor's lifetime. This technology is particularly useful in remote or inaccessible locations where regular maintenance is difficult or impossible. While still embodying a promising technological solution for the synthesis of RF ultra-low power (ULP) or zero energy (ZE) receivers (Rx), EHs suffer from limited conversion efficiency due to minimum required RF voltages required from the non-linear components to trigger RF-to-DC rectification (typically in the mV range).

### Energy Harvesting Summary

With that context, in addition to the improved information receivers discussed above, also provided herein are novel over-the-air (OTA) radio frequency (RF) energy harvester (EH) architectures implementing a microelectromechanical system (MEMS) as a matching network (MN) to improve EH performance, resulting in increased lifetime of ULP Rx for IoT applications. Such architectures can be generally referred to as MEMS-boosted energy harvesters for IoT applications.

In this regard, in some embodiments, high-performance MEMS resonators exploiting different materials and resonant modes, can be successfully implemented as MNs to passively amplify RF signals in ULP architectures. The experimental configuration described below includes a custom-made aluminum nitride (AlN) thin-film bulk acoustic resonator (FBAR) deployed as a high-quality factor MN. In some embodiments, the EH can operate at a similar frequency to the information receivers described above (e.g., 820 MHz) using similar antennae and circuitry (e.g., a sub-50Ω single-meandered antenna on printed circuit board, a MEMS film bulk acoustic resonator (FBAR), and a Schottky diode half-bridge full wave rectifier followed by a sample and hold circuit).

As described below, experimental results demonstrate that the inclusion of the FBAR leads to an improvement of the energy harvester's efficiency, resulting in an 8-fold increase of the harvested power compared to a system without the MEMS resonator. This first demonstration of an increased efficiency over-the-air energy harvester implementing MEMS resonator represent an encouraging and viable solution for ultra-low or zero power electronic devices for Internet of Things applications, including distributed and remote sensor networks.

### Energy Harvester Architecture

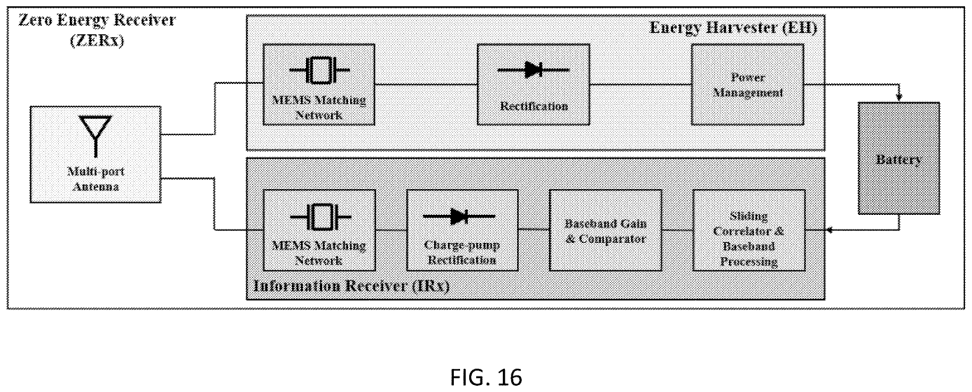

A high level schematic of an envisioned RF zero energy receiver for a distributed IoT sensing network is shown in FIG. 16. The system is includes a multi-port antenna, an information receiver (IRx) branch, an energy harvester branch, and a rechargeable battery. Despite containing active components in the IRx branch, the proposed ZE Rx requires no external energy, relying solely on the power supplied by the EH branch.

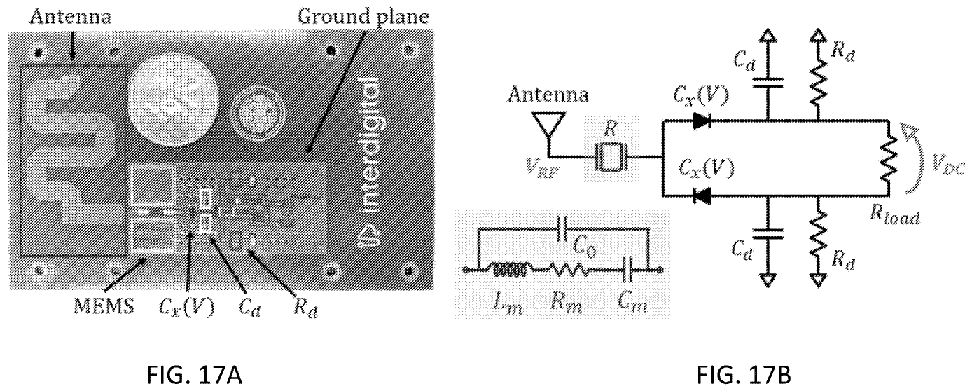

The OTA energy harvester architecture proposed in this disclosure represents a building block of the envisioned ZE Rx and consists in an integrated printed circuit board (PCB) multi-port antenna, a MEMS-based matching network, and a power management unit. For the sake of prototyping, the antenna is optimized for a single frequency and the power management unit is substituted by a simple resistive load to evaluate the conversion efficiency of the OTA EH. Pictures of the manufactured prototype and of its equivalent circuit are reported in FIGS. 17A & 17B, respectively. The system implements a self-resonant antenna operating around 820 MHz realized on PCB FR-4 substrate, an in-house fabricated MEMS FBAR as matching network, two antiparallel Schottky diodes (Cx(V)) arranged in a half-bridge full wave rectifier, and a sample and hold circuit constituted by capacitance (Cd) and resistance (Rd) for each of the rectifier's output branches. The PCB board presents two output pins to interface the circuit to a variable load (R_{load}) for DC voltage and rectified power measurement.

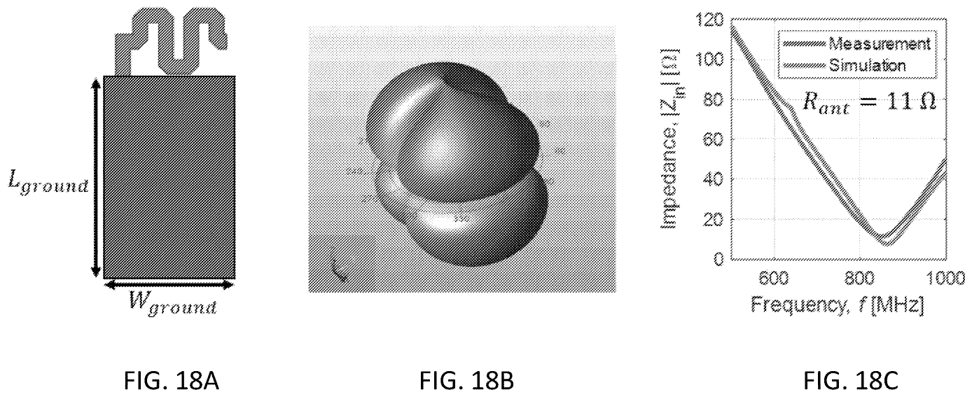

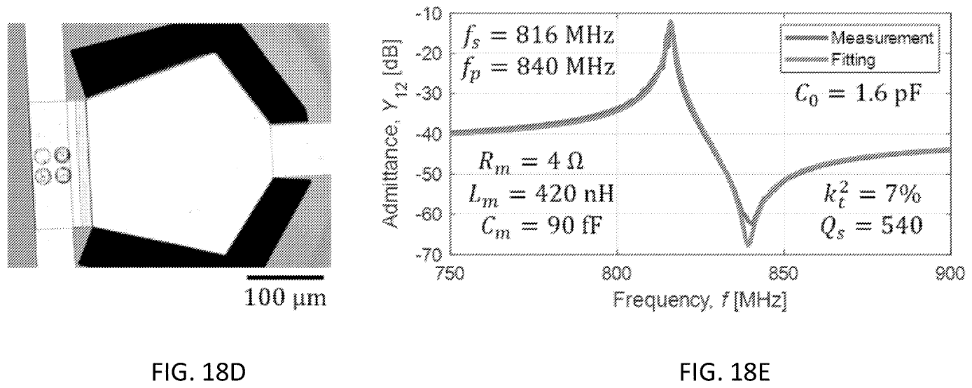

A single-dipole meandered design is chosen for the RF antenna. The dimensions of the meander (length and turns) are set to ensure a resonance 820 MHz and sub-50Ω impedance (|Zin|) at the desired frequency of operation. The ground plane geometry (L_{ground} and W_{ground}, FIG. 18A) is appropriately designed to allow the adoption of a single-meandered antenna in place of a double-meandered configuration. By breaking the antenna's symmetry, is possible to interface the meandered antenna to a single-ended circuit while reducing any return loss and providing a strong ground for the other EH components.

Omni-directional radiation is ensured via ADS EMPro® simulations (FIG. 18B), while simulated |Zin| is verified experimentally after proper de-embedding on an identical manufactured board provided with an SMA access port (FIG. 18C). The resonator implemented for the prototype is an in-house fabricated AlN FBAR (FIG. 18D) operating at 817 MHz, with a quality factor (Qs) of 500 and an electromechanical coupling

$$( {k}_{t}^{2} )$$

of 7% (FIG. 18E), interfaced to the circuit via wire-bonding.

During the OTA EH operation, the RF radiation is captured by the single-meander antenna and converted into an electrical signal. Then, the MEMS matching network resonates out the capacitance of the diode at the desired frequency of operation, building up a large voltage across Cx. Thanks to its nonlinear behavior, the half bridge full wave rectifier converts the RF signal to DC. The presence of the MEMS allows larger voltages across the diode, which ultimately increase the system's efficiency. Ultimately, the sample and hold capacitor (Cd) is used to maintain a constant DC output voltage from the rectifier, while Rd provides a stable reference bias to the diode.

### Energy Harvester Measurements and Results

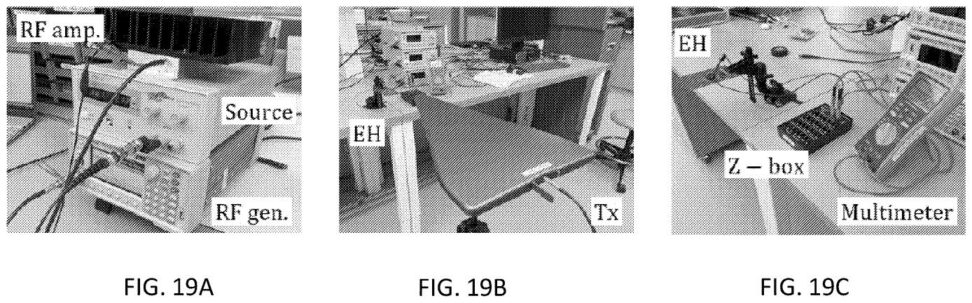

The experimental setup for the energy harvester over-the-air demo is reported in FIGS. 19A-19C. The transmitter (Tx) consists of an RF generator, an RF amplifier, a power source to power the amplifier, and a high-gain (+4 dBi) broad-band directional antenna (Model: Aaronia HyperLOG 4025). The amplifier is powered to add +30 dB to the continuous wave (CW) signal provided by the RF generator and compensate for the estimated path losses of the experimental setup. The OTA EH is placed 0.5 m from the antenna on a plastic holder, and is connected to a resistance decade box (Z-box) via mini hook cables. A digital multimeter is connected in parallel to the Z-box to monitor both the load (R_{load}) and the rectified voltage (VDC). For the case under investigation, the load is set to 10 kΩ.

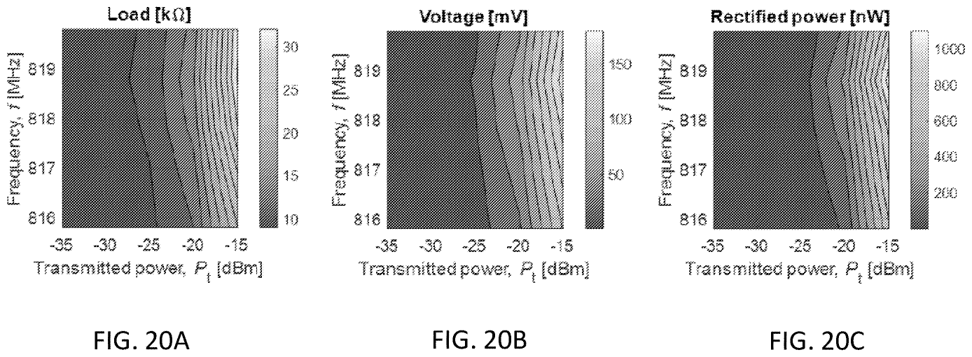

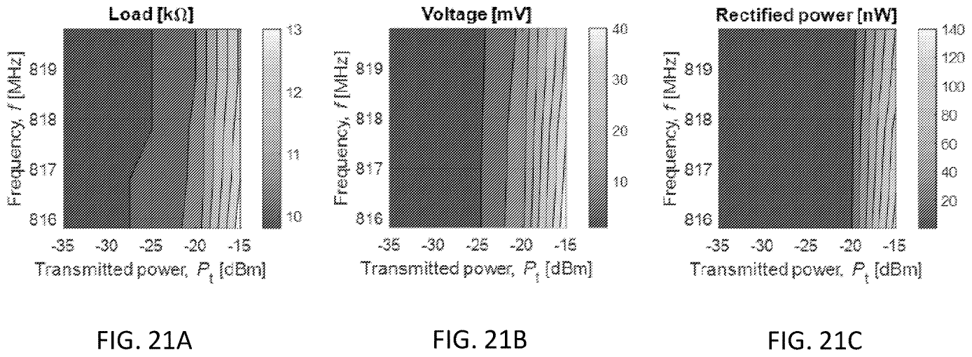

FIGS. 21A-21C and FIGS. 20A-20C report the measured load, voltage, and harvested power for the same OTA EH implementing the FBAR MEMS matching network and without the matching network, respectively. The frequency is swept around the series resonance of the MEMS, to take into account for frequency pulling, while the power is varied between −35 and −15 dBm. As clearly highlighted by the experimental results, the presence of the matching network introduces a frequency-dependent voltage boost, which directly translates to an 8-fold increase in the harvested power.

### FEATURES

A WuRx front-end is discussed at a system level highlighting the possibility of a custom antenna design, with low radiation resistance, providing a better performance than traditional 50Ω power matched RF antennas. A design methodology, utilizing conventional planar PCBs, to improve the performance of WuRxs is illustrated. The novel antenna design is readily integrable with the low-power WuRx circuitry.

An inexpensive and reliable de-embedding method is discussed to overcome the practical challenges associated with non-50Ω antenna measurement using a 50 ΩRF measuring vector network analyzer. An antenna prototype is designed using the proposed methodology and anechoic chamber measurements show that both its impedance and radiation properties are in good accordance with the expected performance.

Further, a simple WuRx is assembled using off-the-shelf components and is utilized in the comparison of the custom low-resistance antenna design to a reference 50 Ω system. The results confirm that the described antenna design can lead to an RF power threshold, i.e., an overall minimum detectable signal of about −61 dBm, which is approximately 13 dB lower than that of the reference design.

A novel RF WuRx front-end for Narrow Band Internet of Things is described herein. The novel methodology leverages the co-design of PCB antennas with MEMS resonators to obtain high passive voltage amplification and sharp frequency selectivity, obtaining a scalable, inexpensive platform for next generation IoT devices.

A PCB antenna design methodology is discussed and experimentally validated, and an in-house fabricated AlN FBAR micro-acoustic resonator is deployed to realize a WuRx with off-the-shelf diode rectifiers. The PCB platform is also used to show that passive voltage gain in a WuRx front-end is limited by parasitic effects rather than MEMS FOM in this frequency range with conventional antenna designs.

The described WuRx is experimentally validated, showing that the limits posed by integration parasitics can be lifted by using the proposed methodologies. A highest-in-its-class RF voltage gain of 23 dB is demonstrated for an over-the-air prototype at 850 MHz, as the antenna and the MEMS are co-designed for high passive voltage amplification, at no cost in terms of power consumption, required antenna gain or improvements in the resonator FoM.

By leveraging the proposed approach, miniaturization, energy awareness and large volume production of IoT nodes can be made more and more attractive for next-generation cellular IoT devices and wearables at reduced link budgets.

In addition, over-the-air energy harvesters for IoT applications are provided using MEMS resonators as matching networks to boost RF-to-DC conversion efficiency. Experimental results showed an 8-fold improvement in the rectified power output at 800 MHz when implementing an aluminum nitride FBAR as a matching element. Despite the limited efficiency attained, these results have important implications for the development of ultra-low power or zero energy receivers, and further research is needed to explore the full potential of MEMS technology for these applications.

Implementing higher figure of merit (FOM), low threshold diodes, and matching the self-resonant antenna's impedance to the matched load could significantly improve the EHs rectification performance, making them more efficient and cost-effective. Overall, these results indicate that MEMS resonators are a promising solution for improving voltage rectification in energy harvester, and to potentially enable the development and deployment of sustainable, distributed sensing networks.

The designs and methods described herein can be used in connection with any of at least the following industrial applications:
1) Wake-up Receivers.
2) Internet of Things nodes communicating over-the-air.
3) Matching networks in commercial electronics (mobile).
4) Power/Energy harvesters with enhanced RF-to-DC conversion efficiency.

It will be apparent in view of this disclosure that the designs and methods described herein include at least the following novel and non-obvious features:
1) Low characteristic impedance compared to 50-Ohm available systems and components (novel feature, not present in literature to the best of the inventors' knowledge)
2) The proposed antenna design maintains high efficiency (>90%), displays electro-magnetic resonance despite lower characteristic impedance, without requiring dedicated matching networks.
3) Compact form factor, planar design.

It will be further apparent in view of this disclosure that the designs and methods described herein include at least the following advantages and improvements over the prior art:
1) Increase gain in matching networks for a given envelope detector/mixer
2) Allows for larger communication link budget (system sensitivity), which is both a performance and financial-based improvement (e.g., less base stations required to communicate with all the deployed nodes).
3) Allows power consumption reduction in wake-up receivers and internet of things nodes when the power budget is noise-limited. This is mainly a financial-based improvement (e.g., less required maintenance) but also a technology enabler for remote sensor networks.
4) Readily deployed in state-of-the-art devices, without the need of redesigning other RF blocks.
5) Provides at least 3 to 5× improvement in the system sensitivity at the same cost of state-of-the-art components and without the need for system redesign.

What is claimed is:

1. A wake-up receiver (WuRx) comprising:
an antenna having a real input impedance different than 50Ω configured for receiving a radiofrequency (RF) signal;
resonant circuitry configured to provide voltage gain to the received RF signal to produce a boosted RF signal; and
a passive rectifier configured to at least one of:
recover a data signal from the boosted RF signal, or
convert the boosted RF signal into a DC power signal.

2. The WuRx of claim 1, wherein the passive rectifier is integrated in a semiconductor integrated chip.

3. The WuRx of claim 1, wherein the passive rectifier includes a diode rectifier.

4. The WuRx of claim 1, further comprising a load capacitor for storing the boosted RF signal when a voltage of the boosted RF signal exceeds a threshold voltage.

5. The WuRx of claim 4, wherein the threshold voltage is higher than a minimum voltage for which messages can be decoded by the WuRx.

6. The WuRx of claim 5, wherein the threshold voltage is higher than a voltage of the received RF signal.

7. The WuRx of claim 1, wherein the resonant circuitry includes a reactive tank including one or more circuit elements.

8. The WuRx of claim 1, wherein the resonant circuitry includes a micro-acoustic MEMS resonator.

9. The WuRx of claim 1, wherein the antenna is an open-end, center-fed, dipole-like antenna.

10. The WuRx of claim 9, wherein the antenna is a meander antenna.

11. The WuRx of claim 9, wherein the antenna is a single-ended meander antenna.

12. The WuRx of claim 11, wherein the antenna includes a single-ended meandered antenna dipole.

13. The WuRx of claim 11, wherein the antenna is grounded.

14. The WuRx of claim 13, wherein the antenna structure includes a construction having a bottom metal ground pour as a path for return RF currents.

15. The WuRx of claim 14, wherein the path for return RF currents results in antenna excitation including a ground connection to break symmetry of differential dipoles of the antenna.

16. The WuRx of claim 15, wherein breaking the symmetry of the differential dipoles of the antenna halves electro-magnetic energy storage in the meander.

17. The WuRx of claim 1, wherein the antenna is a double dipole antenna.

18. The WuRx of claim 1, wherein the antenna is a planar antenna.

19. The WuRx of claim 1, wherein the real input impedance of the antenna is less than 50 Ω.

20. The WuRx of claim 19, wherein inductance and/or capacitance of the antenna produces a tunable complex impedance of the antenna exceeding 50Ω.

21. The WuRx of claim 1, wherein the resonant circuitry is sized to resonate a load reactance of the WuRx.

22. A method for wake-up signal detection comprising:
receiving, with an antenna having a real input impedance different than 50Ω, a radiofrequency (RF) signal;
providing, by resonant circuitry, voltage gain to the received RF signal to produce a boosted RF signal; and
by a passive rectifier, at least one of recovering a data signal from the boosted RF signal or converting the boosted RF signal into a DC power signal.

23. The method of claim 22, wherein the steps of receiving, providing, recovering, and converting are performed using a WuRx comprising:
an antenna having a real input impedance different than 50Ω configured for receiving a radiofrequency (RF) signal;
resonant circuitry configured to provide voltage gain to the received RF signal to produce a boosted RF signal; and
a passive rectifier configured to at least one of:
recover a data signal from the boosted RF signal, or
convert the boosted RF signal into a DC power signal.
